(19) United States
(12) Patent Application Publication
(10) Pub. No.: US 2003/0172020 A1
(43) Pub. Date: Sep. 11, 2003

(54) Integrated intellectual asset management system and method

(76) Inventors: Nigel Paul Davies, Naperville, IL (US); William A. Mariani, Naperville, IL (US); Ralph G. Schroeder III, Burr Ridge, IL (US)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 10/300,547

(22) Filed: Nov. 19, 2002

Related U.S. Application Data
(60) Provisional application No. 60/332,738, filed on Nov. 19, 2001.

(51) Int. Cl. G06F 17/60

(52) U.S. Cl. 705/36

(57) ABSTRACT

A system and method are disclosed for integrated management of an organization's intellectual property. The system and method generate assets for each particular piece of intellectual property within the system. Each asset has particular attributes associated with it which are used to identify and manage the asset through all phases of the intellectual property life cycle.

### CROSS-REFERENCE TO RELATED APPLICATIONS

This application claims the benefit of, and priority from, U.S. Provisional Application No. 60/332,738, filed Nov. 19, 2001, which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The value and importance of intellectual assets (e.g., inventions, patents, trade secret, copyright, etc.) to companies has increased significantly in recent years, and some would argue such value has surpassed the value and importance of hard assets. As such, companies have become more vigilant in protecting, using and enforcing their intellectual assets. To this end, numerous products and services have been introduced into the market place to assist organizations in trying to protect, manage and utilize these intellectual assets. These products and services, however, tend to be relatively simplistic and only focus on a specific limited portion of the intellectual asset creation, management and use cycle (i.e., the “intellectual asset management lifecycle”). For example present docketing systems, patent analysis systems and software licensing programs tend to be very limited.

The intellectual asset management lifecycle, however, is complex and multi-functional, and products and services such as discussed above are inherently limited from being effective comprehensive intellectual asset management tools. Because such products or services each operate on their own, essentially as a “silo”, with little or no data exchange with other lifecycle products or services, important organizational intellectual asset data is overlooked, lost or underutilized as an intellectual asset moves through the different phases of the intellectual asset management lifecycle. These systems also tend to only focus on one asset type or a narrow range of asset types, (docketing=patent applications and patents; license management=licenses), and thus require different processes and procedures to ensure the effective management of these assets within an organization. The organization, as a result, loses valuable opportunities to streamline and reduce costs associated with the management of all assets through their intellectual asset management lifecycle. In addition, the organization loses valuable opportunities to “data mine” its intellectual assets for valuable interrelations or trends.

Accordingly, there is a need for a system and method which provides an organization with an integrated suite of intellectual asset management tools which allow the organization to better create, manage and exploit its intellectual assets. Such a system should be able to provide for new types of assets to be configured and integrated into a seamless asset management process associated with the organization's idea creation, patent prosecution, lead development, licensing, conflicts management and other related practices. There is also a need for such a system and method to provide support for other intellectual capital such as know-how, defensive publications, and agreements in addition to traditional intellectual assets.

### SUMMARY

According to one aspect of the present invention, an intellectual asset management system includes a computer having intellectual asset management instructions loaded thereon and a database. The intellectual asset management instructions, when activated, capture data regarding an item of intellectual property entered into the computer and generate an asset having attributes incorporating the captured data. The intellectual asset management instructions store the generated asset to the database. The intellectual asset management instructions may also include at least one set of stand alone instructions directed to a specific portion of the intellectual asset management process. These stand alone set of instructions may be directed to performing certain functions, such as strategic planning functions; portfolio management functions; invention analysis functions; inventor performance functions; patent procurement functions; licensing management functions; conflict and assertion functions and competitive intelligence functions.

According to another aspect of the present invention, the intellectual asset management instructions interact with a common asset repository, and the intellectual asset management instructions may perform functions available on any asset resident in the common asset repository. The intellectual asset management instructions may be further programmed to emulate an intellectual property lifecycle with the intellectual asset management instructions transforming the attributes of a generated asset at different stages of the lifecycle. The intellectual asset management instructions may also be programmed to interact with search engines to perform asset related searches to return a hit list. The intellectual asset management instructions may associate the returned hit list of search results with a generated asset. According to another aspect of the invention, the intellectual asset management instructions generate assessment criteria for a generated asset. The intellectual asset management instructions may generate scoring numbers based on responses to the generated assessment criteria. The intellectual asset management instructions may modify the attributes of a specified asset due to scoring numbers generated for that asset.

According to another aspect of the invention, a method for managing intellectual assets includes providing information regarding an item of intellectual property, capturing the information provided and generating an asset having attributes which identify a specific item of intellectual property. According to another aspect of the present invention, a computer readable medium having instructions for execution by a computer for performing a method includes capturing information regarding a specific item of intellectual property and generating an asset having attributes which identify the specific item of intellectual property.

### BRIEF DESCRIPTION OF THE DRAWINGS

These and other features, aspects, and advantages of the present invention will become better understood with regard to the following description, appended claims, and accompanying drawings where:

FIG. 1 is a diagram showing an embodiment of how the Integrated IAM system of the present invention provides a single repository for information and common intellectual property lifecycle processes;

FIG. 2 is a diagram showing an overview of exemplary functional components that make up the Integrated IAM system including the core infrastructure components that support integration with both existing intellectual property systems and external entities involved in the intellectual property lifecycle;

FIG. 3 is a diagram describing the various logical deployment components of the Integrated IAM system in one embodiment;

FIG. 4 is a diagram that describing the computer servers involved in a typical physical deployment of the Integrated IAM system;

FIG. 5 is a diagram that provide details of components that make up the client layer of the system in one embodiment;

FIG. 6 is a diagram that provide details of components that make up the presentation layer of the system in one embodiment;

FIG. 7 is a diagram that provide details of components that make up the business logic layer of the system in one embodiment;

FIG. 8 is a diagram showing the architectural components of the Integrated IAM system in one embodiment;

FIG. 9 is an exemplary screen capture of the portfolio management tree and the summary screen for a specific portfolio;

FIG. 10 is an exemplary screen capture of the asset list screen for a specific portfolio;

FIG. 11 is an exemplary screen capture of the Workspace List Asset system;

FIG. 12a is an exemplary screen capture of the relationship mapping application-citation view;

FIG. 12b is an exemplary screen capture of the relationship mapping application-timeline view;

FIG. 12c is an exemplary screen capture of the relationship mapping application-family map view;

FIG. 12d is an exemplary screen capture of the relationship mapping application-classification view (summary);

FIG. 12e is an exemplary screen capture of the relationship mapping application-classification view (expanded);

FIG. 12f is an exemplary screen capture of the Hit list for a remote search on an external research web site;

FIG. 12g is an exemplary screen capture of the bibliography information for a specific hit on an external research web site;

FIG. 12h is an exemplary screen capture of the full text information for a specific hit on an external research web site;

FIG. 12i is an exemplary screen capture of the download workfile screen on an external research web site;

FIG. 12j is an exemplary screen capture of the references tab on the invention disclosure form;

FIG. 13 is an entity diagram of the database tables associated with an exemplary security logical data model;

FIG. 14 is a diagram showing the relationship of a user to security groups and permissions;

FIG. 15 is a diagram showing what permissions types are supported by the security manager;

FIG. 16 is a diagram showing an exemplary system controlled workflow;

FIG. 17 is a diagram of a simple workflow configuration supporting the, case management process;

FIG. 18 is a diagram of a complex workflow configuration supporting the invention evaluation process across multiple divisions within an enterprise;

FIG. 19a is an exemplary screen capture of Workflow Group Step List screen which may be used to list all active workflow steps that can be performed by a specific group of system users;

FIG. 19b is an exemplary screen capture of Workflow My List screen which may be used to list active workflow steps for the current user;

FIG. 19c is an exemplary screen capture of the workflow step assignment screen;

FIG. 20 is an entity diagram of exemplary database tables associated with a Workflow logical data model;

FIG. 21 is a flow diagram providing details of exemplary state transitions associated with an invention asset;

FIG. 22 is an exemplary screen capture for a dashboard that displays key metrics and system activities for the user;

FIG. 23a is an exemplary screen capture for an attachment to an invention asset screen which may be used to list, add, edit and view attachments associated with the invention;

FIG. 23b is an exemplary screen capture of a viewer for a Word document attachment;

FIG. 24 is an entity diagram of exemplary database tables associated with the document (attachment) logical data model;

FIG. 25 is a diagram that provides details of exemplary components that make up the integration layer of the system;

FIG. 26 is a diagram that provides example integration points between the Integrated IAM application and external systems;

FIG. 27 is a diagram that provides details on an interface to a docketing system in one embodiment;

FIG. 28 is a diagram that provides details of components that make up the resource layer of the system in one embodiment;

FIG. 29 is a sequence diagram that shows a sample interaction between the architecture layers and components in one embodiment;

FIG. 30 is a diagram that provides details on the interaction between the client and presentation layers of the system in one embodiment;

FIG. 31 is a diagram that provides details on the interaction between the presentation and business layers of the system in one embodiment;

FIG. 32 is a diagram that provides details on the interaction between business logic and resource layers of the system in one embodiment;

FIG. 33 is a diagram that provides details of the hierarchy of elements which make up the asset objects within the system in one embodiment;

FIG. 34 is a diagram that provides details of the elements which make up the asset package within the system in one embodiment;

FIG. 35 is a diagram that provides details of the elements which make up the component package within the system in one embodiment;

FIG. 36 is a diagram that provides details of the elements which make up the invention package within the system in one embodiment;

FIG. 37 is a diagram that provides details of the elements which make up the Patent package within the system in one embodiment;

FIG. 38 is an entity diagram of exemplary database tables associated with the asset logical data model;

FIG. 39 is an entity diagram of exemplary database tables associated with the invention logical data model;

FIG. 40 is an entity diagram of exemplary database tables associated with the patent logical data model;

FIG. 41 is an entity diagram of exemplary database tables associated with the asset categorization logical data model;

FIG. 42 is an entity diagram of exemplary database tables associated with the filing strategy logical data model;

FIG. 43 is an exemplary screen capture of the filing strategy tab on the invention asset screen which may be used to enter and edit information about the planned filing strategy for the invention;

FIG. 44 is a diagram that shows how question definitions can be combined to make up survey definitions in one embodiment;

FIG. 45 is an entity diagram of exemplary database tables associated with the assessment logical data model;

FIG. 46a is an exemplary screen capture of the questions tab on the invention disclosure form which may be used to capture information about the invention using a system generated set of questions;

FIG. 46b is an exemplary screen capture of the assessment tab on the invention asset screen which may be used to list assessments that have been performed on the invention;

FIG. 46c is an exemplary screen capture of the assessment entry screen which may be used to list collect input from a reviewer about the invention using system generated questions;

FIG. 47 is an exemplary screen capture of the question and answer tab on the invention asset screen which may be used to list questions and answers associated with the invention;

FIG. 48 is an entity diagram of exemplary database tables associated with the dialog (Q&A) logical data model;

FIG. 49 is an entity diagram of exemplary database tables associated with the activity reminder logical data model;

FIG. 50 is an entity diagram of exemplary database tables associated with the notification logical data model;

FIG. 51 is an entity diagram of exemplary database tables associated with the dashboard logical data model;

FIG. 52 is an exemplary screen capture for the dashboard configuration screen which may be used by a user to configure what dashboard gauges are displayed for a specific workspace;

FIG. 53 is a diagram that provides details of the activities involved with creation and conducting meetings within the system in one embodiment;

FIG. 54 is an entity diagram of exemplary database tables associated with the meeting logical data model;

FIG. 55a is an exemplary screen capture of the My Meeting tab on the meeting management screens which may be used to list all meetings where the current user is an attendee;

FIG. 55b is an exemplary screen capture of the unscheduled asset tab on the meeting management screens which may be used to list asset that need to be scheduled for a meeting;

FIG. 55c is an exemplary screen capture of the meeting summary tab for a specific meeting which may be used to enter and edit key information about the meeting;

FIG. 55d is an exemplary screen capture of the meeting agenda tab for a specific meeting which may be used to list assets that are currently scheduled to be reviewed at a meeting;

FIG. 55e is an exemplary screen capture of the select asset for meeting screen;

FIG. 55f is an exemplary screen capture of the meeting attendee tab for a specific meeting which may be used to list, edit and add attendees to the meeting;

FIG. 55g is an exemplary screen capture of the select attendee for meeting screen;

FIG. 55h is an exemplary screen capture of the meeting distribution tab for a specific meeting which may be used to list, edit and add users to the meeting distribution list;

FIG. 55i is an exemplary screen capture of the meeting conduct tab for a specific meeting which may be used to record the results of a meeting;

FIG. 56 is a block diagram that provides details on the capabilities of the local search feature within the system in one embodiment;

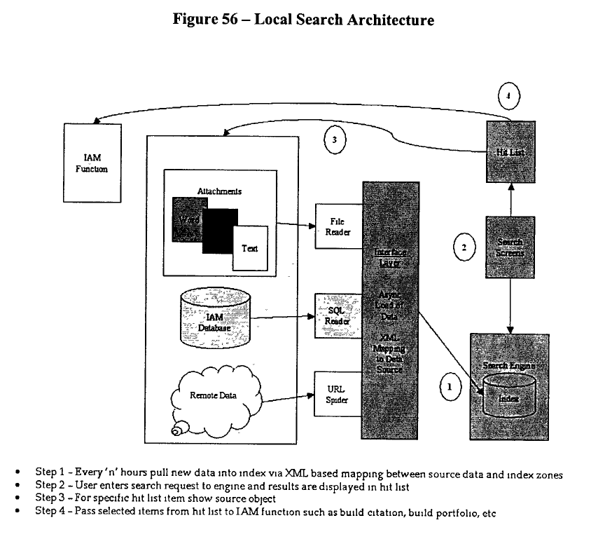

FIG. 57 is a block diagram that provides details on the integration with a Research Web Site to support remote searching of patent collections in one embodiment;

FIG. 58a is an exemplary screen capture of a Research tab on the Invention Disclosure Form which may be used to execute either system or user configured searches of both remote and local data repositories;

FIG. 58b is an exemplary screen capture of the references tab on the invention disclosure form which may be used to record either structure or unstructured references that may be relevant to the invention;

FIG. 59 is a block diagram that provides details on the architecture of the Relationship Mapping Application in one embodiment;

FIG. 60 is an exemplary screen capture for the system login screen associated with the systems security manager;

FIG. 61 is a diagram that summarizes the overall “invention to patent” lifecycle in one embodiment;

FIG. 62 is a diagram that provides details on the activities involved in the creation and submission of an Invention Disclosure in one embodiment;

FIG. 63a is an exemplary screen capture of the Instructions tab on the Invention Disclosure Form which may be used to provide the user instruction on how to enter the Invention Disclosure Form into the system;

FIG. 63b is an exemplary screen capture of the Summary tab on the Invention Disclosure Form which may be used to enter high level information about the idea and categorize the invention;

FIG. 63c is an exemplary screen capture of the Inventor tab on the Invention Disclosure Form which may be used to enter details of the inventors responsible for creating the idea;

FIG. 63d is an exemplary screen capture of the Contact tab on the Invention Disclosure Form which may be used to enter details of any contacts and their role associate with the idea;

FIG. 64a is an exemplary screen capture of the Summary tab on the Invention Asset screen which may be used to enter and edit high level information about the idea and categorize the invention;

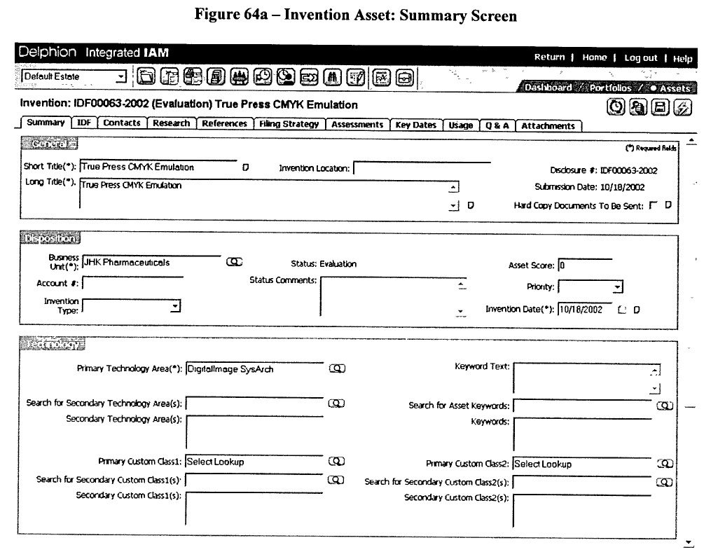

FIG. 64b is an exemplary screen capture of the Key Dates tab on the Invention Asset screen which may be used to enter and edit key dates about the invention;

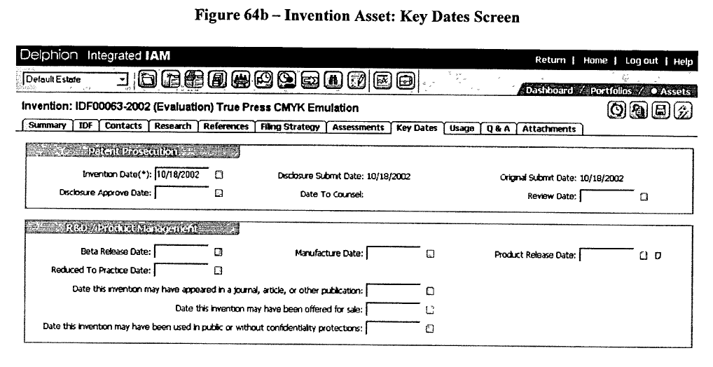

FIG. 64c is an exemplary screen capture of the Usage tab on the Invention Asset screen which may be used to enter and edit current or future usage information about the invention;

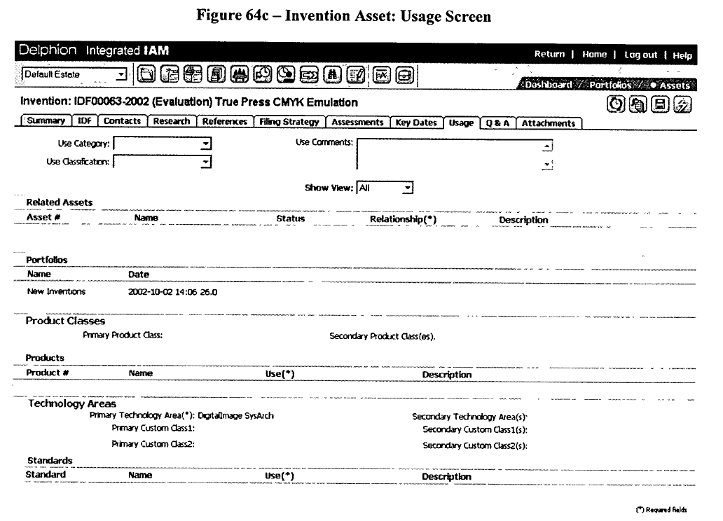

FIG. 65 is a diagram that provides details on the activities involved in the evaluation of an Invention Disclosure in one embodiment;

FIG. 66 is a diagram that provides details of the activities involved with managing the processing of a patent application within the system in one embodiment;

FIG. 67 is a diagram that provides details on the activities involved with managing the maintenance of a patent within the system in one embodiment;

FIG. 68 is a diagram that provides details on the activities involved with managing a Conflict or Assertion within the system in one embodiment; and

FIG. 69 is a diagram that provides details on the activities involved with managing a License Opportunity within the system in one embodiment;

### DETAILED DESCRIPTION

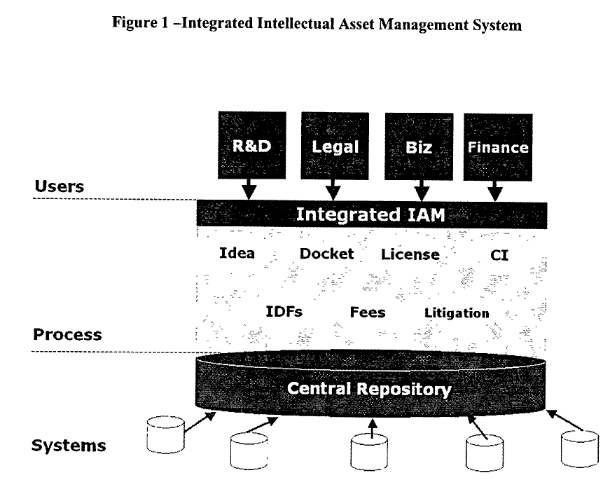

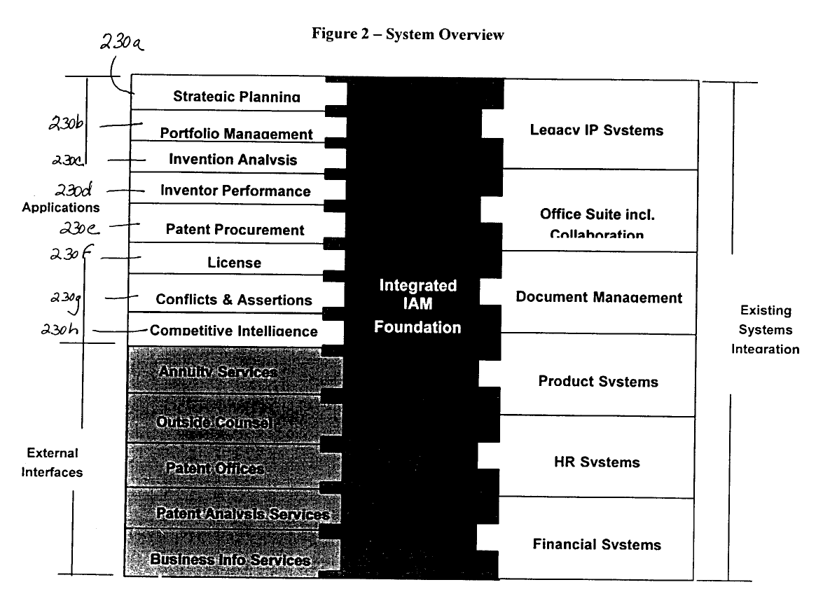

Referring to FIG. 1, the system and methods of the present invention allow multiple functional domains of the intellectual asset management (“IAM”) system to work together in a common process. FIG. 2 illustrates how the system of the present invention, an integrated intellectual asset management system, may be built on a core foundation that supports integration of the internal functional modules via common services and user features. As also depicted, this foundation also support the integration of other existing enterprise systems or external service providers and regulatory agencies such as national patent offices.

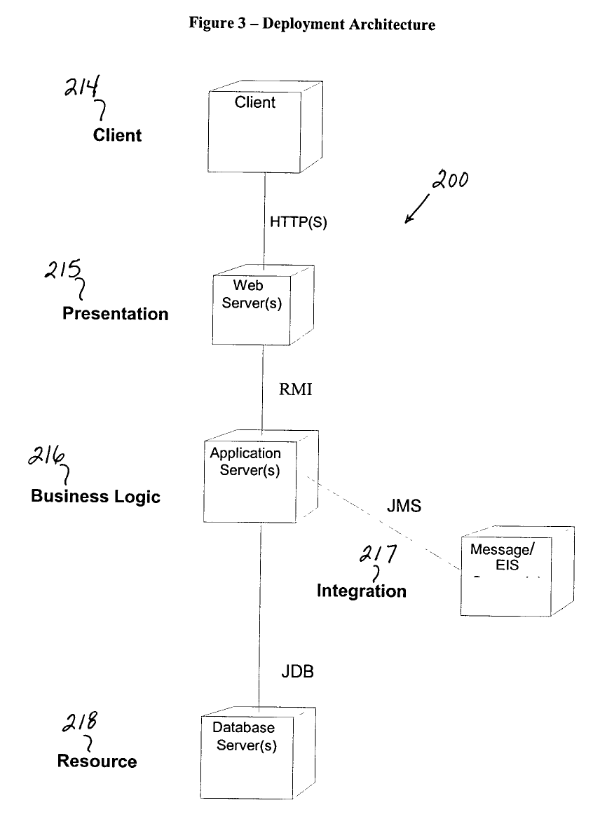

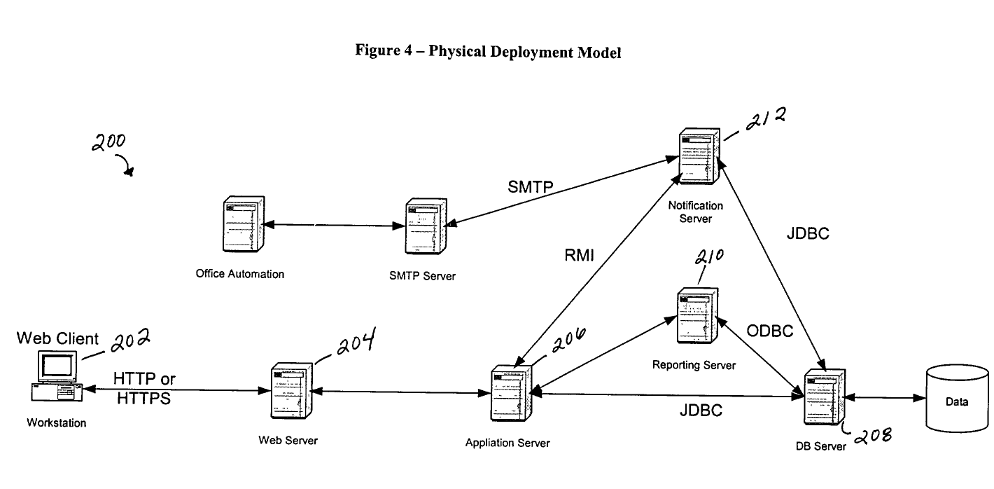

Referring to FIGS. 3 and 4, in this embodiment, the system 200 includes at least one client computer 202, a web server 204, an application server 206, a database server 208, a report server 210 and a notification server 212 all in communication with one another in a computer-networked environment. The client computer interacts with the components of the system through a standard web browser, such as Microsoft's Internet Explorer, resident on the client computer. It should be understood that this server/network arrangement is shown only by way of example and that the system of the present invention could use any server/client computer arrangement and that many or all of the functions described above could be consolidated into a single server. Further, it should be noted that only one client computer and one of each server and data resource is depicted to simplify the explanation and that it should be understood that the system of the present invention may be scaled to handle any number of client computers with the necessary servers and database resources.

In one embodiment, the intellectual asset management system 200 is built on a J2EE architecture that is designed to support specific unique requirements of the intellectual asset management lifecycle. In this embodiment, the design architecture of the intellectual asset management system 200 is based on a Model-View-Controller (“MVC”) pattern. Model-View-Controller design organizes an interactive application into three separate aspects: one for the application model with its data representation and business logic, the second for views that provide data presentation and user input, and the third for a controller to dispatch requests and control flow.

FIG. 3 shows the five-layer architecture of an embodiment of the system 200 of the invention, it includes a client layer 214 which acts as the View aspect in the MVC model; a presentation layer 215 which acts as the Controller aspect in the MVC model; a business logic layer 216 which acts as the Model aspect in MVC model; an integration layer 217 which provides interfaces to external systems; and a resource layer 218 which provides resources to persist business objects and execute business logic. As shown in FIG. 3, the system 200 of the present invention may employ the Hypertext Transfer Protocol (“http”); HTTPS; Java Database Connectivity (“JDBC”), the standard Java API for authentication and access to database resources; Remote Method Invocation (“RMI”), the communication protocol used by J2EE; and Java Message Service (“JMS”), a Java API to enable point-to-point and publish-and-subscribe messaging between systems.

### Client Layer

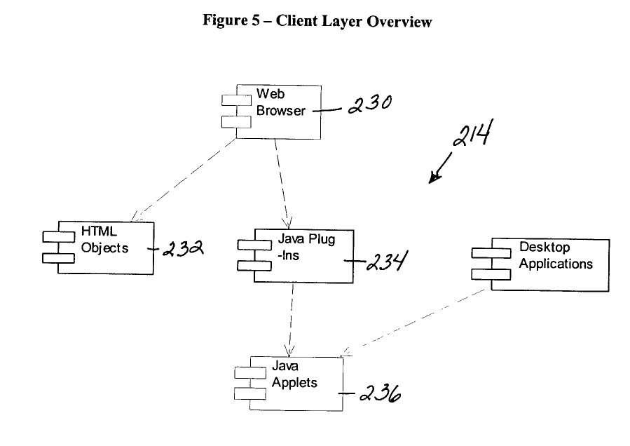

Referring to FIG. 5, the client layer 214 is responsible for interacting with the user to present the user-interface and to capture user inputs. The client layer 214 also accesses data from the model and specifies how that data should be presented. The client layer 214 updates data presentation when the model changes. The client layer 214 includes a web browser 230 which posts HTTP requests to the presentation layer 215 and displays HTML objects 232 from the response. A Java plug-in 234 may be used to serve a Java applet 236 from a presentation layer JSP Page and to execute the applet 236 on the client layer 214.

### Presentation Layer

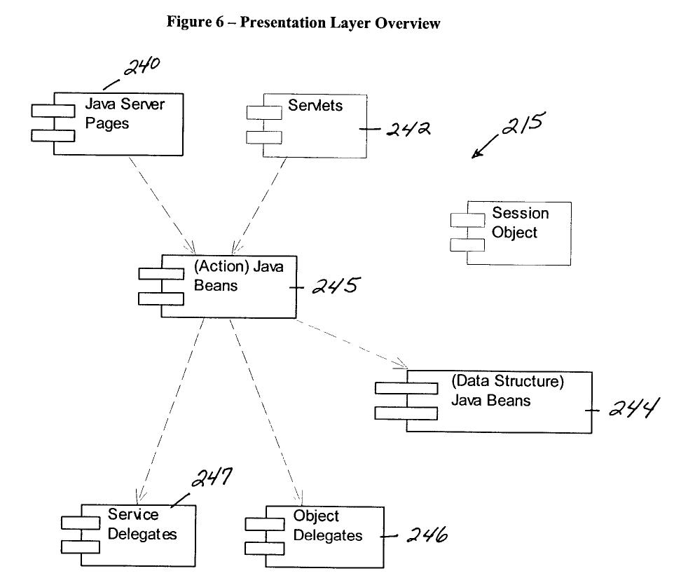

Referring to FIGS. 3, 4 and 6, the presentation layer 215 in this embodiment resides on the web server 204. The presentation layer 215 interacts with a business logic layer 216, described below, to provide information in response to client requests and acts to persist updates. In addition, the presentation layer 215 dispatches user requests and selects views for presentation. The presentation layer 215 interprets user inputs and maps them into actions to be performed by the model. The presentation layer 215 also selects the next view to be displayed based on a user's interactions and the outcome determined by the model operations. The components of the presentation layer 215 may include Java server pages 240, servlets 242, Java beans, and delegate classes. Java server pages (“JSP”) 240 provide the ability to generate dynamic content for a presentation layer response to a client layer request. A JSP page is a text-based document that describes how to process a request to create a response. A JSP page contains an HTML template used to format the response presentation and JSP elements and scriptlets to generate the dynamic content in the response. JSPs are compiled into servlets by the application server at runtime. Servlets 242, or Java servlets, are web server components that accept an HTTP request from a web browser (i.e., client layer 214) and return an HTTP response. Requests are directed to the web server servlet engine, the web server then executes the appropriate servlet 242 and returns the response to the client layer 214. Date structure Java beans 244 encapsulate data used at the presentation layer 215. This is typically data obtained from the business logic layer 216 through an object or service delegate or data related to the capture of user input. Action Java beans 245 map a specific client layer request to an action, which implements the application logic to respond to the request. Object delegates 246 encapsulate the services and data provided by the business logic layer 216 for a given business object. Delegates 246 shield the presentation layer 215 from the complexity of the business logic layer 216 implementation environment and decouple the presentation and business logic implementations. Object delegates 246 encapsulate the data structure of the business object in the form of a package or value object, and only expose the appropriate behavior and data to the presentation layer 215. Object delegates 246 act as a controller by directing presentation layer requests to the appropriate business logic layer components. Service delegates 247 encapsulate the services and data provided by the business logic layer 216, similar to object delegates 246, but for a given set of business objects. This may be a collection of objects of the same type or a collection of different business objects related in some business context. Service delegates 247 act as a controller by directing presentation layer requests to the appropriate business logic layer components.

### Business Logic Layer

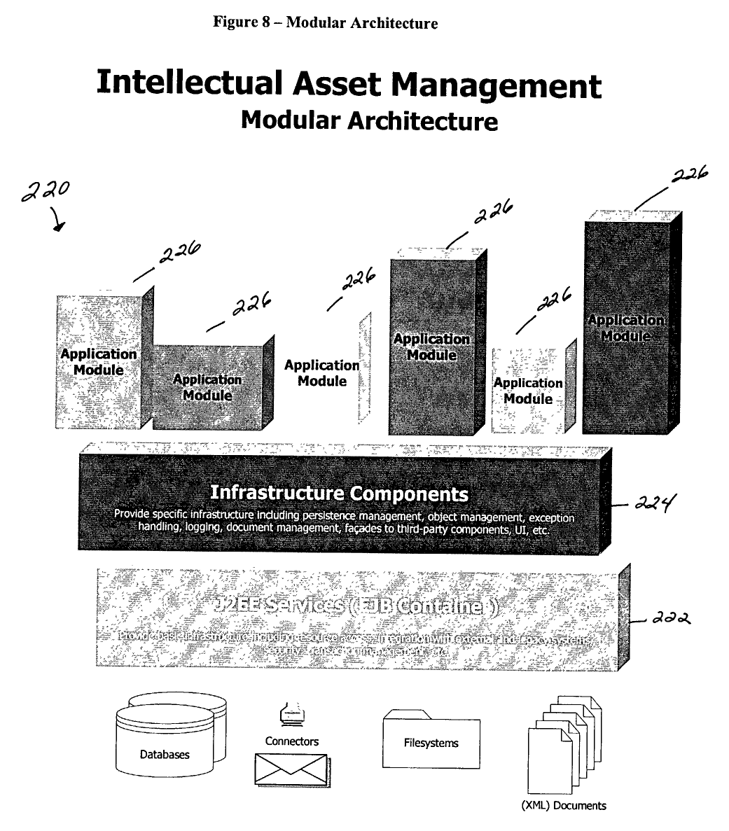

Referring to FIGS. 2, 3, 4 and 7, the business logic layer 216 resides on the application server 206 and provides the infrastructure for developing and deploying multi-tiered enterprise applications. The business logic layer 216 implements the core business logic of the application and interfaces to the underlying business application components. In the EJB environment, these business components receive support from the application server containers, facilities for managing component life cycle, transaction support and resource allocation. Referring to FIG. 8, encompassed in the business logic layer 216 is an intellectual asset management application 220 which resides on the application server 206 as well. The intellectual asset management application 220 has two primary framework layers: an operating system layer 222 and an application support framework layer 224. The operating system layer 222 provides basic general computing infrastructure and functionality, such as resource access, integration with external and legacy systems, security, transaction management services, among other things. The application support framework layer 224 provides more specific application infrastructure and functionality, such as persistence management, object management, exception handling, logging, document management, facades to third-party components, user interfaces, among other things. The intellectual asset management application 220 may also include application modules 226 which, when provided, are integrated with and interact with the application support framework layer 224. The application support framework 224 handles tasks which are common to all modules. Such a design and the use of application modules 226 allows the application 220 to be configured as desired by the system user. This gives the system a tremendous amount of flexibility.

Referring to FIGS. 2 and 8, exemplary functional modules 226 which may be utilized in the intellectual asset management application 220 are described below:

### Strategic Planning Module

The intellectual asset management application 220 may have a strategic planning module 230a. The strategic planning module 230a provides the capability to define and monitor high-level management metrics associated with the intellectual property lifecycle. This includes having the capability to provide information on such things as the number of invention disclosures submitted in the past three (3) months, the number of patent applications to be submitted in a calendar year, revenue goals for licensing intellectual property assets associated to a specific technology, among other things.

### Portfolio Management Module

The intellectual asset management application 220 may also include a portfolio management module 230b. The portfolio management module 230b allows an enterprise to organize, manage and analyze its estate of intellectual assets. Specifically, the portfolio management module 230b allows an enterprise to ensure it is pursuing the appropriate amount of patent protection for its products and technologies; improve its efficiency and effectiveness in capturing information about its assets; allow business and research and development management to visualize how patents impact their business strategies, products, technologies, etc.; provide the enterprise the ability to identify, understand and visualize otherwise unknown or unidentified connections between intellectual assets, in particular between patents and groups of patents; provide the organization the ability to understand the use of a given asset and its alternative value propositions, including the asset's use in products, its future potential, its value in blocking competition and its associated revenue (product sales or licensing); provide the organization the ability to quickly and accurately understand the history and genealogy of an asset; provide the organization with tools to quickly and accurately report and disseminate information about its portfolio and strength of its intellectual property to interested parties, such as investor relation personnel and market analysts; provide the organization with a tool to accurately calculate and understand the costs associated with protecting intellectual assets worldwide and the costs associated with maintaining such protection of these intellectual assets; and provide the organization with the ability to create and track the effectiveness of the organization's intellectual property plans. The system 200 can manage any type of asset, including patents, trade secrets, know-how, trademarks, copyrights, and proprietary technology, among other items.

In an embodiment of the invention, the portfolio management module 230b employs four main organization and management concepts: 1) the concept of an intellectual asset estate; 2) the concept of an intellectual asset workspace; 3) the concept of an intellectual asset portfolio and 4) the concept of intellectual assets. An “estate” is an organization's entire set of intellectual property assets represented as in a hierarchal tree. A “workspace” is a subset of the estate that is used to group branches of the estate to support easy referencing. An intellectual asset “portfolio” is a specific branch of the tree of the estate created by a system user. Portfolios are groupings or organizational views of the estate created based on a system user's preferences. For example, a portfolio might be defined for a product. The “product portfolio” then represents a subset of the estate of intellectual assets that protect or are related to the product. Each portfolio has its own profile defined by information about why the portfolio was created, how it has been (or will be) managed and a specification of its use objectives. As the portfolio grows, the portfolio profile gains additional information.

With respect to the fourth concept, an “intellectual asset” is any asset entered into the system. System assets typically take the form of a disclosure, an application or a patent. Because system assets typically undergo various changes during the course of development, many system assets will take on each of these three forms during development. In addition to the developmental status of the asset, the system 200 also maintains information on asset characteristics or attributes to provide a full complement of information about the asset. These attributes are required so a system user may fully understand and manage the asset. Like a portfolio profile, an asset's attribute information becomes more complete as the asset matures. Importantly, asset attribute information is collected throughout the process. Underlying portfolio management module rules and/or workflow processes prompt users to collect information as appropriate for the current status of each asset throughout the process.

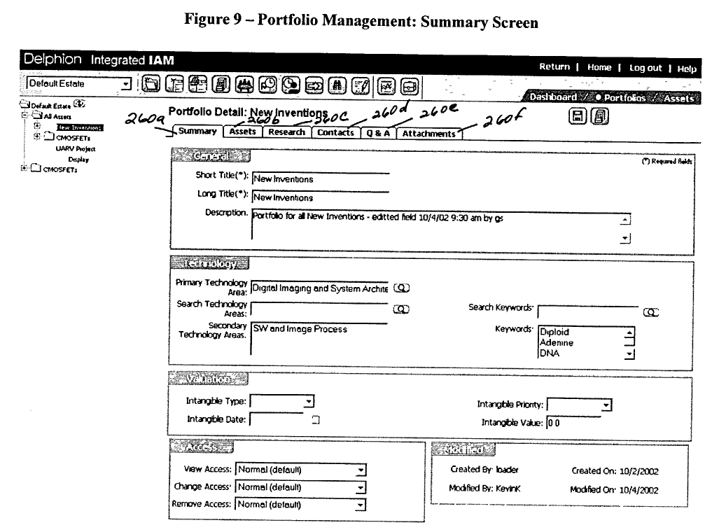

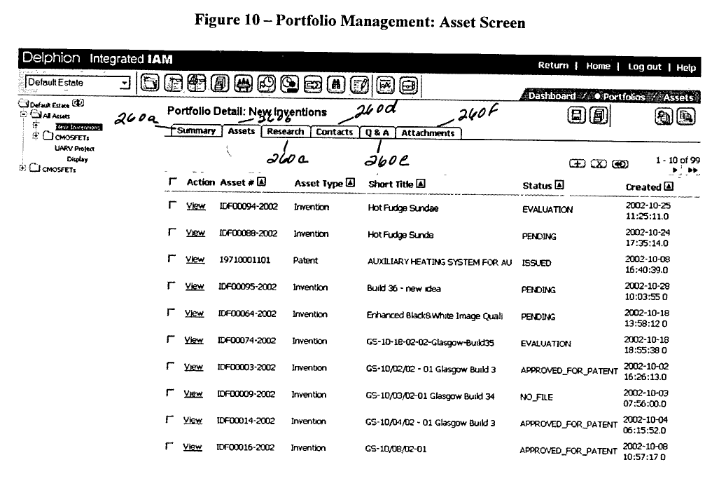

FIGS. 9 and 10 depict exemplary user interfaces generated by the portfolio management module 230b in an embodiment of the invention. Tabs 260 are generated for different views of the portfolio data. The tabs 260 available for a portfolio may include:

“Summary” Tab 260a—Provides high level descriptive information for the portfolios;

“Assets” Tab 260b—Provides the ability to list the assets that are associated with the selected portfolio plus add, delete, move and copy assets as required;

“Research” Tab 260c—Provides a listing of various search strings that are associated with the portfolio. These search strings can be associated with multiple data repositories either within the intellectual asset management system 200 or available on the Internet. This research information can be used to add assets to the portfolio;

“Contacts” Tab 260d—Provides the ability to list contacts and organizations that are associated with the portfolio plus add and delete assets as required. For each entry, a role can be specified to provide context to the relationship;

“Q & A” Tab 260e—Provides the ability to list questions and associated answers for a portfolio. In addition, this function provides a user with the capability to ask new questions or answer pending questions;

“Attachments” Tab 260f—Provides the ability to list attachments associated with the portfolio plus add, edit, delete and view these attachments; and

Other tabs can also be displayed based on a user's security profile and such things as plans, activities, etc may be included.

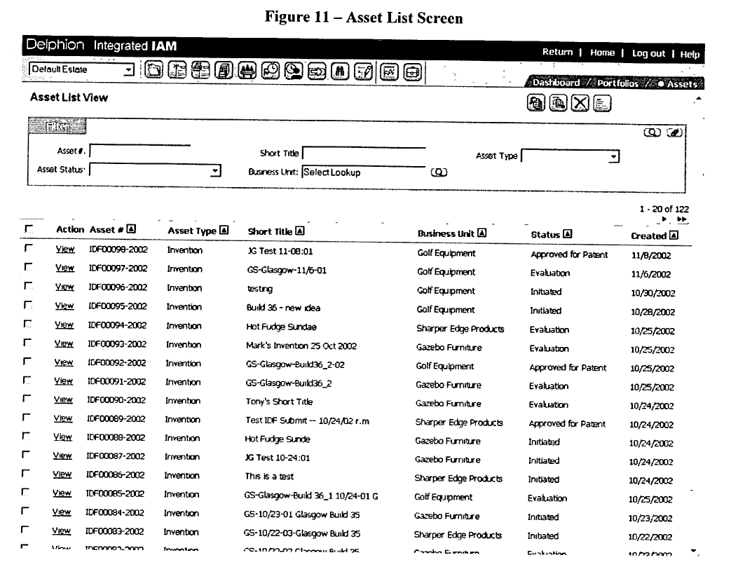

FIG. 11 represents an alternative view of a workspace in the form of a flat list of intellectual assets that can be filtered by using common criteria.

The portfolio management process is initiated by creating a portfolio. The portfolio is populated, among other ways, with assets found in the entire estate; assets copied or moved from other portfolios or assets downloaded from external data repositories such as internet web sites, data warehouses, etc. As explained above, assets are typically disclosures, applications or patents. Patents and post-publication applications (e.g., after 18 months) may be loaded into the system from publicly available resources through a download or other means. However, non-public intellectual assets, such as disclosures and pre-publication applications, are typically entered into the system by the organization using some other means, manual or automatic. Manual methods may involve a search, copying/moving from an existing portfolio, or creating a new asset from scratch (eg., an invention disclosure has just been completed and the information about it needs to be added to the database as an asset). Automatic methods may involve the assignment of assets by the system according to a query that is defined in the portfolio profile and a periodic update from a patent service database (including the downloading of new patents and applications). Automatic updating can be selected for any portfolio, and this ensures that assets are added to the portfolio as they are added to the database.

Whenever new assets are added to a portfolio (either manually or automatically) a notification is provided to the owner(s) and/or users of the portfolio alerting them of the added assets. For shared portfolios, explained below, the community of users receive similar notification.

A portfolio is defined by its “portfolio profile” and the assets which comprise it. The portfolio profile captures information about the portfolio definition and about the management of the portfolio. Importantly, the profile may include planning information that a system user uses to measure a portfolio's performance (e.g., assets created versus assets planned).

Portfolios may be “personal” or “shared”. Personal portfolios are created and maintained by individuals and are not available outside the respective portfolio management module environment. “Shared” portfolios are created and maintained either by the organization itself or by an individual within the organization and are open for distribution to the entire company (with the ability to establish read/write controls). These may include the ability to share with the entire company, divisions, teams or any other type of grouping. Libraries of portfolios can be created and accessed throughout the enterprise to improve collaboration and the dissemination of information (e.g., a company might create portfolios for each of their products). In addition to the above methods, a personal portfolio may be created by copying a shared portfolio and changing its access to “personal”. This method, however, still allows automatic updating back to the shared portfolio.

In addition to organizing and collecting information about the estate, portfolio and assets, the portfolio management module also supports the processes of (1) planning and (2) paying maintenance fees. “Planning” involves establishing goals and objectives for creating new assets for a given portfolio (e.g., how many new assets are we going to create this year) and tracking the creation of assets against these goals (e.g., planned v. actual performance.) “Maintenance” involves tracking the world-wide annuity payment due dates for each asset, and the decision process for either paying or dropping patent rights.

Searching, reporting and analysis are important parts of the portfolio management module. An organization needs to understand what is contained in its estate and have the capability to identify trends, strengths and weaknesses. The portfolio management module 230b therefore provides robust facilities to search, report and analyze an organization's estate. Searching allows the ability to identify otherwise unknown relationships between assets. The reports generated by this module are easy to create and publish, and the analysis that this module performs extracts useful business intelligence. The portfolio management module 230b also provides administrative tools to allow the reallocation of assets when an organization reorganizes itself, acquires new assets or loses assets because of sale/divestiture.

### Invention Analysis Module

The intellectual asset management application 220 may also include an invention analysis module 230c. (FIG. 2). The invention analysis module 230c supports the process of identifying, articulating and capturing invention ideas and determining how the asset will be processed and made part of a portfolio. The system handles the complete workflow, which begins at the time the idea is identified, and runs through the steps of invention assessment and patent review and determination.

For many organizations, this is often the first step taken to initiate the securing of patent rights. The purpose of the form is to allow an inventor to provide sufficient information to determine whether a patent should be pursued. The criteria are usually: (1) whether the invention constitutes patentable matter (e.g., meets the legal requirements), and (2) whether the company should make the investment in securing a patent (e.g., meets the business objectives). In one embodiment of the invention, the invention disclosure form includes a request for at least the following information:

Name of All Inventors

Title

Short Description of the Problem and Solution

Advantages of Invention Over Alternative Solutions

Type of Invention (e.g., Material, Process, Composition, Method of Manufacture)

Relevant References

Example of Application of Invention

Invention Date and Witness Name

Some organizations require prior art searches, either by the inventor or a patent professional, as part of the disclosure process. The invention analysis module 230c provides access to patent repository databases to conduct prior art searches. The prior art search query may be derived directly from the invention disclosure form itself (e.g., the questions in the invention disclosure form may be directly converted to a search query strategy) or from a query developed by the searcher.

Once an invention disclosure form is submitted, the invention analysis module 230c supports the systemization of the evaluation process by incorporating the model of a Patent Review Board into the module's business rules. The invention analysis module provides for an invention disclosure form single or multi-step routing mechanism and an evaluation tool. The invention disclosure form, once submitted, is routed to appropriate Patent Review Board members according to predefined routing mechanisms (e.g, an email will be generated to certain people who have been assigned to the Patent Review Board-the system tracks each Patent Review Board member's current allocation of cases.) Included with the evaluation notice, the system 200 sends each Patent Review Board member a link to the invention disclosure form along with associated information (e.g., prior art search) useful in scoring the evaluation.

Once all evaluators have completed scoring the disclosure, the system generates an aggregated score. Based on the score, the system can be setup to prioritize disclosures and/or route to the next appropriate step. For those not suitable for moving to the next phase, the system can return the invention disclosure form to the appropriate contributors (e.g., inventors) for additional information, if warranted. The invention analysis module 230c also supports the scheduling of Patent Review Board face-to-face meetings where the process calls for an inventor presentation.

The four primary activities supported by the invention analysis module 230c include:

Invention Disclosure—The module 230c provides for the entry of the invention details and associated supporting information via an on-line form completed by the inventor. This form can be adapted based on system rules to support different data and categorization requirements based on the organization, technology or other attributes of the invention asset. The disclosure process provides the ability to facilitate both local and remote searching of company assets, such as defensive publications, invention disclosures, applications and patents. This allows an enterprise to eliminate duplicative invention filings and improves the quality of the disclosures and expedites the submission process;

Prior Art and Reference Art Searching—The module 230c provides the capability to search for information on one's own company and other companies' using both internal (intra-enterprise) and external (extra-enterprise) information using local and remote repositories. The ability to save search strings and results is also supported. The capability provided by this module 230c of associating public data with a private asset's details, including relevant references, notes and comments, is a powerful tool in streamlining the evaluation and subsequent application process;

Invention Assessment—The module 230c helps the enterprise identify ideas that meet business objectives and assists in the determination of whether the company should invest in pursuing a patent. The system includes a flexible process, which enables multiple users to score the inventions based on an assessment survey built on key criteria of the invention asset such as business unit, technology and/or product group, etc. These assessments can be further refined based on a user's role within the process such as whether he or she is providing a technical, business or legal review. In an embodiment of the invention, these reviews are completed on-line and automatically associated with the invention asset for easy access and review later on. Assessments are time-specific so it is possible to maintain a history of the evaluation scores as an asset progresses through its full lifecycle;

Review Boards—The invention analysis module 230c may support a number of different methods to review and record decisions about the disposition of an intellectual asset. As an invention progresses through this process, all parties involved are notified of its current state and progress. If required, questions can be addressed to the inventors or others involved in the evaluation. The answers to these questions can be entered on-line and be automatically associated to the invention asset. In one embodiment, two types of review processes supported by the system 200 are: 1) on-line virtual committees and 2) review meetings. With on-line virtual committees, the system 200 supports the ability for a user to assign a reviewer from a candidate list on an as needed basis to review a single disclosure. Once the disclosure has been reviewed, a final decision can be recorded. All these activities may be performed on-line which allows for a more collaborative process. With review meetings, the system 200 also supports the ability to schedule a formal meeting where one or more assets will be reviewed. Which committee reviews a disclosure is based on business rules that consider key attributes of the invention including business unit, technology, etc. Once a committee has been selected, an agenda can be created, attendees selected and the meeting scheduled. The system 200 provides support in the conduct of a review meeting. The system 200 provides the capability to record the results of a meeting and once the meeting is closed, the asset discussed is advanced through system 200 with all appropriate workflows updated on the recorded decision.

### Inventor Performance Module

The intellectual asset management application 220 may also include an inventor performance module 230d. (FIG. 2). Some organizations use a patent incentive program to encourage inventors to submit their inventions for patenting. Patent incentive programs are often provided as combinations of monetary awards and peer recognition (e.g. plaques and award ceremonies), and the incentive program can play an important role in motivating participation in the patent process. Incentives are usually paid at stages of the patent process (e.g., at disclosure, application filing, patent issue), and are paid to inventors and other participants in the process. For a single patent, there typically may be multiple people who receive an award.

The inventor performance module 230d provides the capability to monitor the invention submission activities and track resolution. The inventor performance module 230d also provides the capability to track who receives payments and awards under an organization's patent incentive program. As such, the module 230d reduces the administrative effort typically associated with a patent incentive program. The inventor performance module 230d provides support for the administrative process of assigning or calculating patent incentive program awards using business rules defined by the organization—e.g., based on the importance of the invention and the number of other patents filed by the inventor. These rules may have a number of factors and may change periodically to reflect policy and specific “promotion” events by the organization. The inventor performance module 230d may be integrated with other systems to carry out the patent incentive program role. Specifically, the inventor performance module 230d may be integrated with and interact with: 1) human resource systems to gain inventor information, 2) financial systems to process payment requests and 3) award companies that create the personalized patent awards.

### Patent Procurement Module

The intellectual asset management application 220 may also include a patent procurement module 230e. (FIG. 2). The patent procurement module 230e supports the process of securing patent rights to an invention. The primary focus is on the process from an asset-by-asset basis, rather than from a portfolio basis as with the portfolio management module 230b. The patent procurement module 230e is utilized very early in the asset generation process. The patent procurement module 230e is utilized as soon as an idea is identified and is utilized throughout the steps of evaluating an invention, completing an application, filing an application, prosecuting the application and maintenance. The objective of the patent procurement module 230e is to provide an automated workflow that directly supports the procurement process, as well as provide the information and services routinely provided by “docketing” systems (e.g., tracking tasks, due dates and events). The patent procurement module 230e allows an organization to improve the ease-of-use, quality and consistency of information collected as part of the invention disclosure process; accurately and timely evaluate disclosures as they enter the patent process; link assets directly to their business owners, technologies and products including an up to date status of each asset as it progresses through the process; distribute the patent process—including both inside the company and to third party service providers—to allow the best person to take responsibility for each step of the process; allow efficient production of application documents including world-wide filings for inventions; support electronic filing and status checking with the U.S. Patent and Trademark Office and other patent authorities; improve the efficiency and effectiveness of patent administration in tracking dates and activities as the asset tracks through the prosecution process; allow easy budget estimates and tracking of costs associated with each asset; support an efficient and effective patent maintenance review process and automate decision making and payment activities to the various authorities.

The patent procurement module 230e provides an information collection mechanism linked to an organization's intellectual property creation process. As an asset moves through the various stages, the patent procurement module 230e proactively manages the collection of information by indicating to users information what is required versus what has been actually collected. These alerts prompt users to maintain and update the information in the system 200 and to keep it current.

Importantly, the patent procurement module 230e focuses on managing the legal aspects of an organization's intellectual estate as opposed to managing the business aspects of an organization's estate, which is more in the realm of the portfolio management module 230b. This is in contrast with many presently available “docketing” systems, which have been awkwardly re-purposed to address certain aspects of the portfolio management process by combining these two functions.

The patent procurement module 230e focuses on tracking an asset throughout the legal creation lifecycle. In doing so, patent procurement module 230e supports the following major aspects of the process: (1) transition from invention analysis to case preparation, (2) application preparation, (3) prosecution (U.S., Other Domestic, and Regional), (4) maintenance payment administration, and (5) administration (e.g., assignment of cases, invoicing, forms, etc.).

Once an invention disclosure form is approved, the system 200 places it in the queue for assignment to an attorney (in-house and/or outside counsel). The patent procurement module 230e allows legal administrators to view current workload and understand the business rules for assigning new invention disclosure forms and applications. For example, in-house counsel may be assigned based on business unit or technology—outside counsel may be assigned based on technology and knowledge of the invention's subject matter. Among other aspects of the interaction with outside counsel, budgeting and invoicing are important.

The patent procurement module 230e supports the disclosure of the invention information to the assigned attorney. If the system user has set up the system as such, the system will automatically populate disclosure form information into a template for transmittal to the application-preparing attorney.

The patent procurement module 230e may maintain docketing information and perform docketing services. The patent procurement module 230e also provides a means for forecasting maintenance payments, notifying users of upcoming due dates and allowing users an opportunity to select a maintenance decision (the patent procurement module 230e supports the automatic routing of decision forms to the appropriate parties—e.g., allows a portfolio manager to send a maintenance decision form to a business manager).

The patent procurement module 230e may also support the electronic payment of maintenance fees through a service provider—e.g., Computer Patent Annuities—or through local patent attorneys or agents assigned in each country.

### License Management Module

The intellectual asset management application 220 may also include a license management module 230f. (FIG. 2). The license management module 230f supports activities related to new business ventures such as alliances, partnerships, and joint development. Also, the license management module supports the creation and management of licenses including in-licensing, out-licensing, cross-licensing and the intellectual property-related aspects of standards. Specifically, the licensing management module 230f provides an organization with workflow, collaboration and information resources to support the full lifecycle of business development and licensing; allows the organization to eliminate duplicative efforts or inaccuracies in business development by allowing accurate, timely and comprehensive information about business development efforts, agreements and obligations to be shared; allows information to be easily and conveniently shared between business development professionals and across the various business areas thereby increasing collaboration and coordination; eliminates missed or inaccurate payments or other obligations thereby reducing significant legal risk by not meeting requirements or losing value by not receiving what is required; allows forecasting of business development efforts including financial obligations and receipts; provides for efficiently and effectively managing the flow of information and documents associated with business development, agreements and obligations; and allows historical information and knowledge about business development and licensing to be archived for future reference.

The license management module 230f supports and incorporates features to support the five primary activities in license management: (1) project definition, (2) opportunity creation, (3) lead tracking, (4) agreement drafting, negotiation and execution, and (5) agreement management (obligations). With respect to agreements in effect, the license management module 230f focuses on assuring that contract obligations are met (both getting and receiving). These activities can be both financial (e.g., R&D payments, execution payments, milestones, and royalties) and non-financial (e.g., notices, reports, meetings, renewals, patents, publications and infringement proceedings). The license management module 230f may generate alerts and notifications to the appropriate system users to assure compliance.

### Conflicts and Assertions Module

The intellectual asset management application 220 may also include a conflict and assertions module 230g. (FIG. 2). The conflicts and assertions module 230g supports an organization's process for resolving pre-litigation disputes that arise between an intellectual property owner and an alleged intellectual property “abuser”. Conflicts relate to when an organization receives notification that it is potentially infringing or misusing the intellectual property of another. Assertions are when a company identifies and pursues another party for misusing its intellectual property. Specifically, the conflicts and assertions module provides an organization with an automated process that standardizes the identification/notification (getting or sending), evaluation and resolution of conflict matters; provides for the timely receipt of notices and other requests related to pursuing conflict or assertion opportunities; enables and supports proactive targeting of assertion-based opportunities including allowing the portfolio management process to feed into the assertion process; provides for accurately following policy and procedures for evaluating and corresponding with conflicting third-parties to reduce risk from possible infringement claims; provides for accurately tracking the conflict process and allowing the entire conflict and assertion team to understand and follow the case's history and simplifies and improves the usability of the conflict resolution process to enable reliable conflict decision and evaluation.

The conflicts and assertions module 230g provides the information and workflow support needed to track the full conflict/assertion lifecycle. In addition, collaboration is important to assure efficiency in the dynamic interactions between the involved business and functional areas. The conflicts and assertions module 230g provides an integrated reporting and analysis tool to allow negotiators to take a strong position based on comprehensive and accurate information. Competitive Intelligence Module

The intellectual asset management application 220 may also include a competitive intelligence module 230h. (FIG. 2). The competitive intelligence module 230h provides extended search, reporting and analysis capabilities beyond the standard tools provided as part of each other module. Unlike the portfolio management module 230b which focuses on understanding an organization's own portfolio, the competitive intelligence module 230h is focused on competitive intelligence and analyzing the intellectual property of others. Specifically, the competitive intelligence module 230h allows an organization to understand important competitive indicators and trends related to assignee issuances, inventor activities, technology focus points, etc.; visualize patent data and analyze findings in a way that makes it easy to identify important trends; support easier, more active collaboration between roles in the competitive intelligence process; enable true enterprise-wide access to patent data and analysis capabilities; organize patent research projects in a way that minimizes rework, allows efficient project execution, and supports team sharing and collaboration; utilize advanced machine-based analysis that allows very large amounts of patent data to be understood; and leverage focused data sets that are closely aligned with subject matter area and the tools.

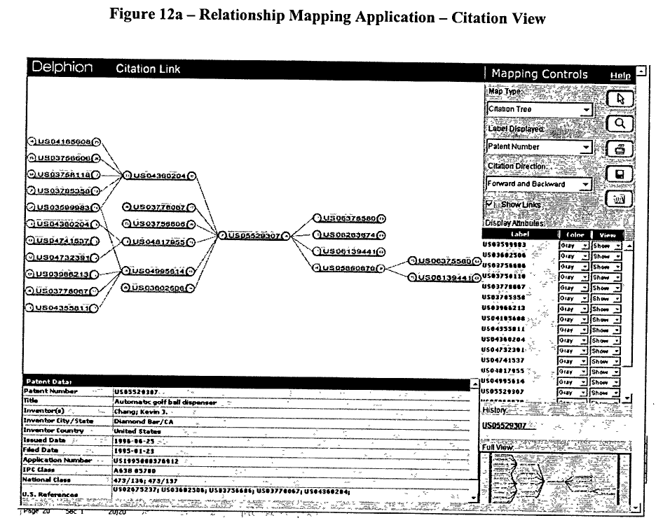

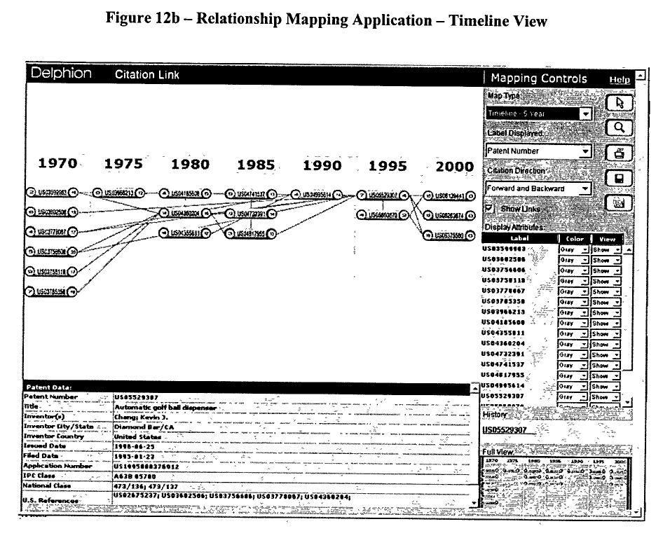

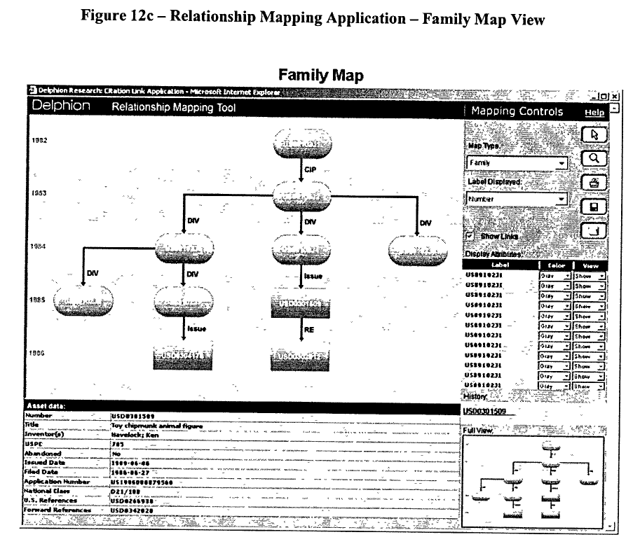

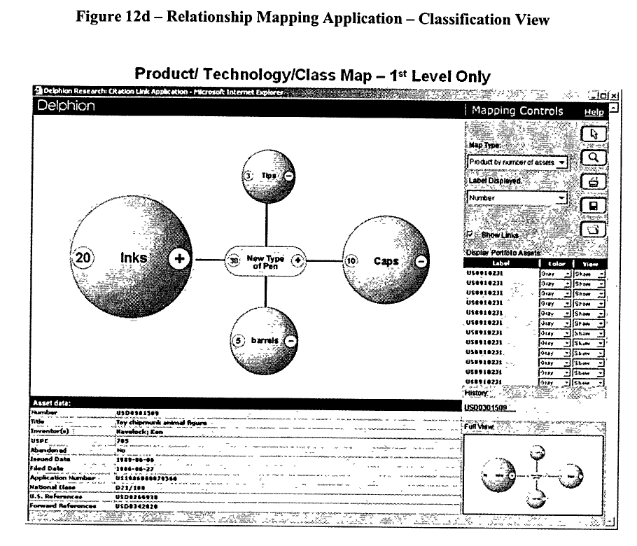

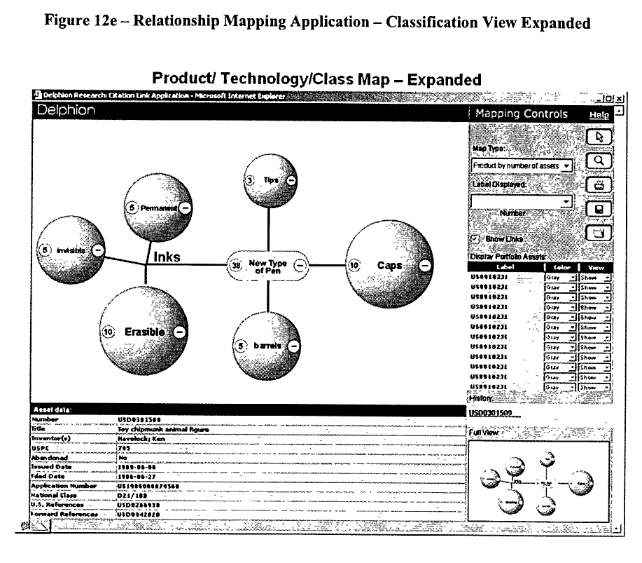

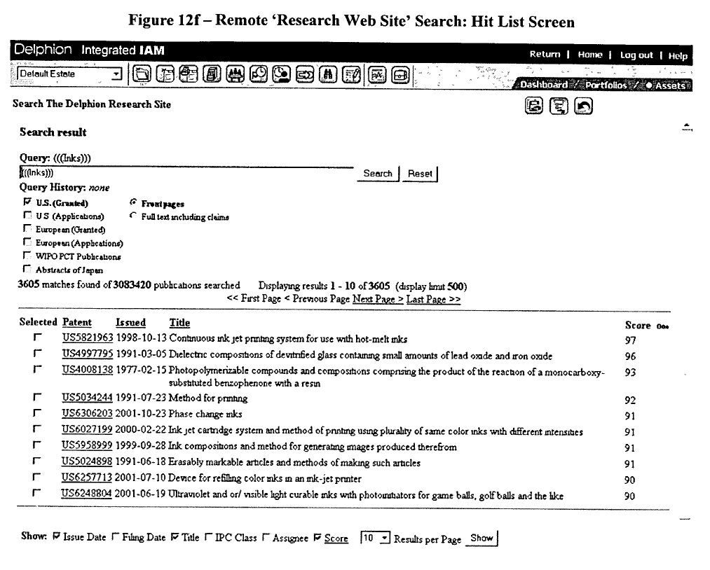

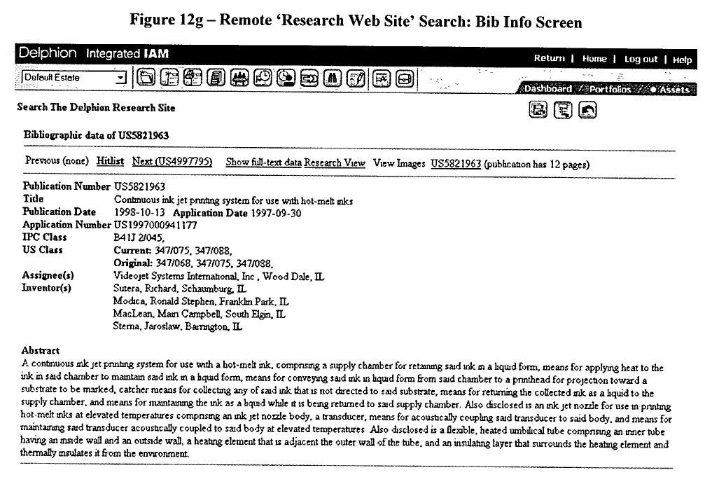

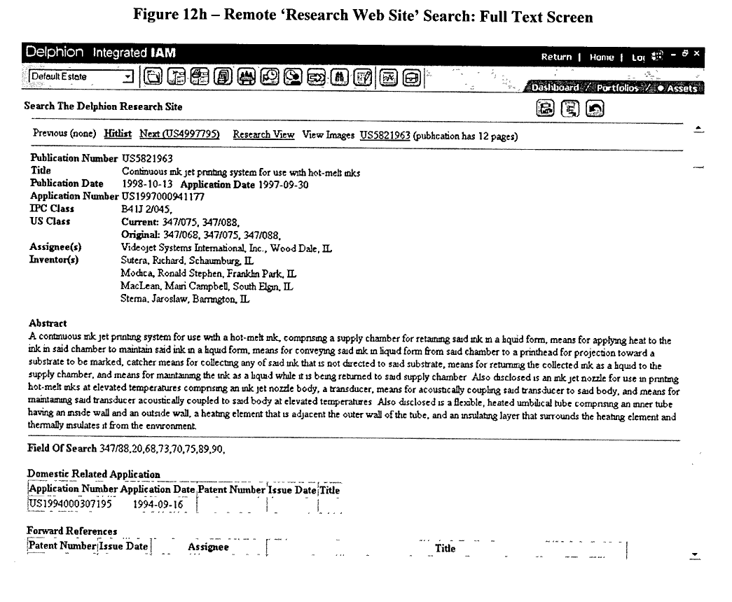

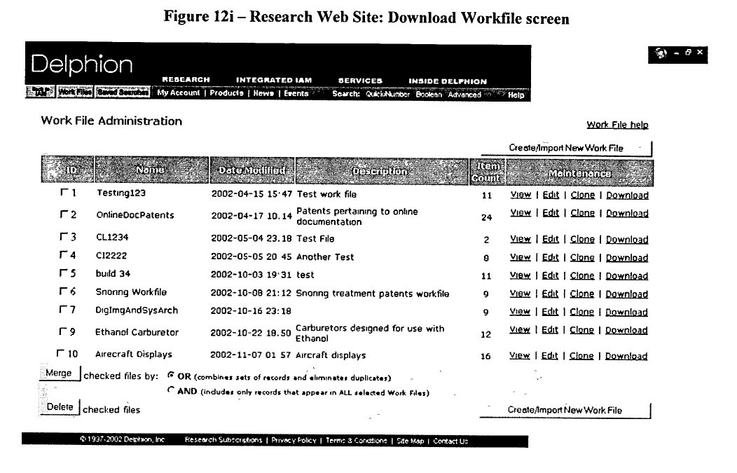

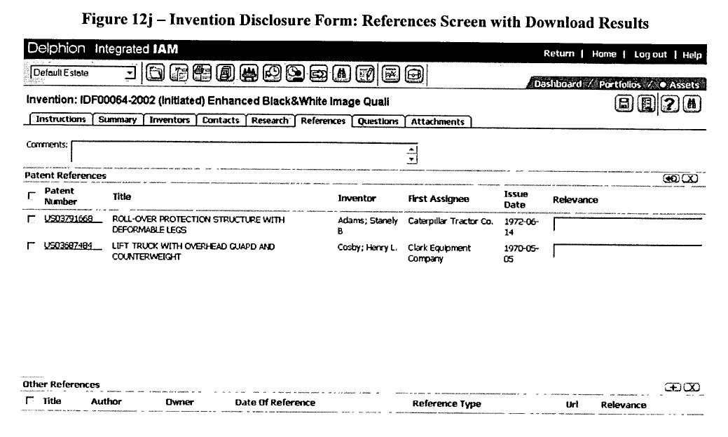

FIGS. 12a-12j are exemplary user interfaces generated by the competitive intelligence module 230h for the advanced searching and analysis component. Studies that may be supported by the competitive intelligence module 230h include freedom to operate/right to practice searches; due diligence for licensing; due diligence for acquisitions; exclusivity and term extensions; patentability/prior art searching; technology assessment planning; commercial risk management. The competitive intelligence module 230h is based on supporting the following major search and analysis steps: 1) project management and collaboration, 2) searching, 3) data access, 4) alerts and notifications and 5) reporting, visualization and analytics.

The competitive intelligence module 230h coordinates the patent research process by organizing and facilitating the collaboration between the different business and functional area users interested in patent intelligence. The competitive intelligence module 230h enables research groups or communities of interest to collaborate on projects and on-going alert programs. The competitive intelligence module tools closely link the searching, reporting and analysis features to important usability features (e.g., 1) links to underlying full-text and images, 2) image editor and annotation tools, 3) note pads for annotations, 4) project folders to save results, and 5) email, instant messaging and community sharing.) The competitive intelligence module search facilities use more advanced searching capabilities in place of the native database search engines provided with the application support framework layer 224. In one embodiment, the search engine may query all databases in the solution and enhance search capabilities in each module. The search engine and index are optimized for patent data. Included in the searching ability of the competitive intelligence module 230h is the ability to save searches. Users require query strategies to be saved (and later recalled). Also, users may elect for the competitive intelligence module 230h to automatically update a saved search (and notify users of added records). In an embodiment, the competitive intelligence module 230h is configured to access all U.S. patents and applications, regional documents (PCT and EP-A and EP-B), country patents and applications (JAPIO, etc.) and INPADOC legal status.

Users of the competitive intelligence module 230h may setup alerts and notifications that the system automatically generates. These alerts may be received through email and/or through some type of notification within the application (e.g., a “my page” screen).

In an embodiment of the competitive intelligence module 230h, the module 230h allows for the exportation of all reports and visualizations to Microsoft Office applications for more user-familiar manipulation and/or presentation. Examples of reports and visualization include:

Patent issuance trends by year/assignee/technology

Citation analysis trees

Patent family trees

Patent maps (e.g., by technology)

In addition to reporting and visualization tools, the competitive intelligence module 230h allows users to analyze patent data in a more complex, multi-dimensional manner. This includes such analyses as:

Clustering (e.g TKM, OmniViz)

Citation analysis by year/technology/assignee

Co-citation analysis

Data mining (e.g., co-inventor clustering).

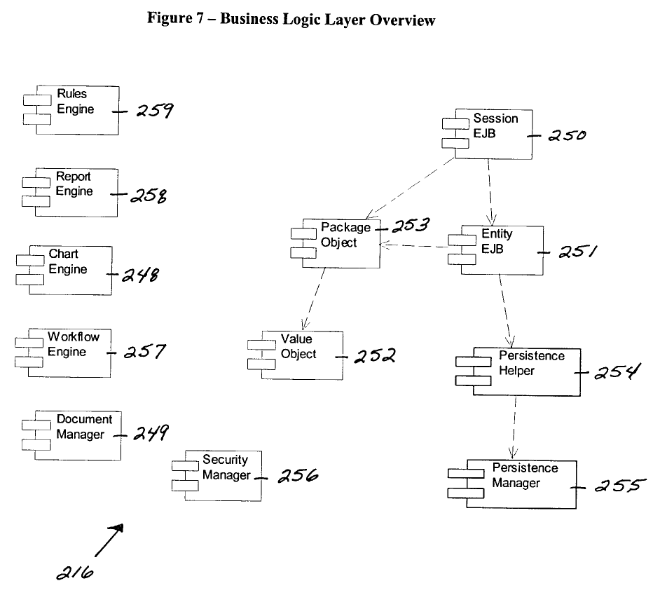

Referring now to FIG. 7 again, the business logic layer 216 may include Session EJBs 250, Entity EJBs 251, value objects 252, packages 253, persistence helpers 254, a persistence manager 255, a security manager 256, a workflow engine 257, a rules engine 258, a report engine 259, a chart engine 248 and a document manager 249. The Session EJBs 250 contain the application business logic and provide an interface to manipulate individual and aggregate business objects. Session EJBs 250 also interact with Entity EJBs 251 to perform persistence operations (add, update, delete) to the resource layer 218. The Session EJBs 250 are also responsible for providing data and services to the presentation layer 215 (typically through the interface provided by the object and service delegates 246, 247). The Entity EJBs 251 represent coarse-grained or complex business objects. Entity EJBs 251 provide an object representation of persistence data (from the resource layer 218) and concurrent object access. An Entity EJB 251 caches the concurrent instance of the business object by holding onto a package 253 or value object 252, which represents the underlying data structure. Entity EJBs 251 are managed by application server containers and use persistence helpers 254 to interact with the resource layer 218. Value objects 252 implement no business logic and are only used to encapsulate the data structure of individual business objects and provide accessor and mutator methods for each attribute in the data structure. The use of serializable value objects 252 as the medium of exchange between Entity EJBs 251, Session EJBs 250 and object delegates 246 reduces the number of remote calls between the presentation layer 215 and the business logic layer 216, improving application efficiency. Packages 253 are used to encapsulate the data structure of aggregate business objects, holding each component of the aggregate object using a value object 252. Packages 253 provide accessor and mutator methods for each value object 252 in the aggregate data structure and limited business logic for composing the aggregate object and validating updates.

Each business object implements a persistence helper 254 to encapsulate the interaction with the persistence manager 255 for specific persistence operations (get, add, update, delete). The persistence manager 255 encapsulates the data persistence interface between the business logic layer 216 and the resource layer 218 and uses an Object-to-Database Map to interpret business object requests from the business logic layer 216. The persistence manager 255 uses this information to then construct and execute an appropriate SQL statement against the database in the resource layer 218, in this embodiment using JDBC. A key capability of the persistence manager 255 is to support the ability to add and extend asset definitions on an as-needed basis. The mapping between the physical data store and the system objects is configured within an XML mapping document. Once changed, the persistence manager 255 dynamically extends the object definitions for presentation and manipulation by the presentation layer 215 and other business components.

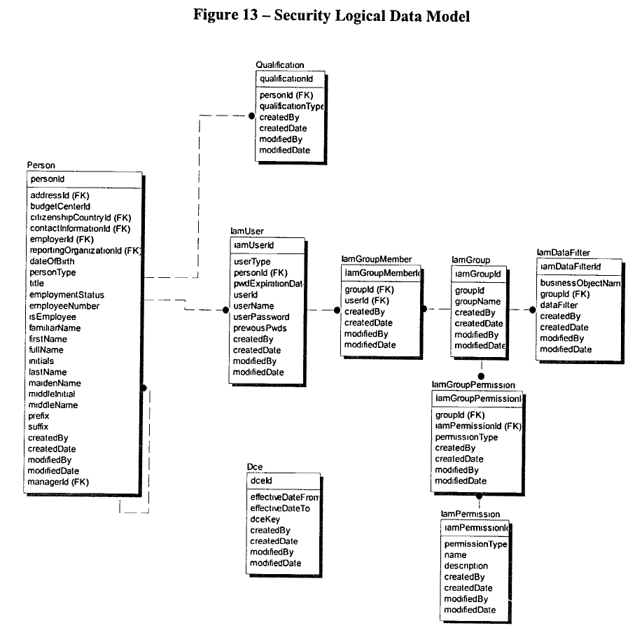

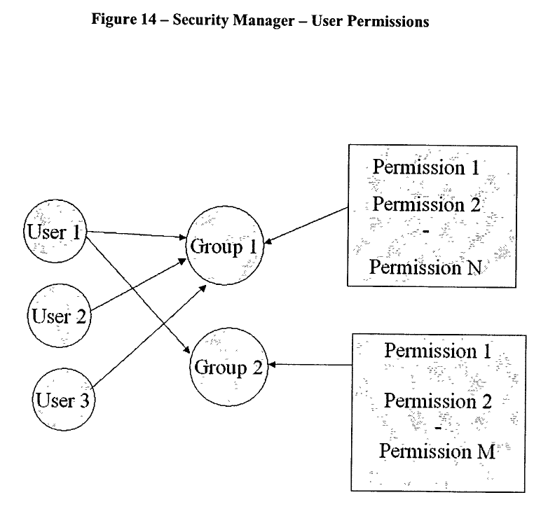

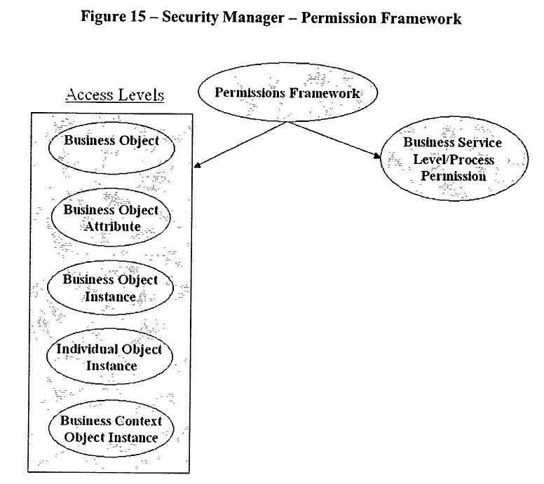

The security manager 256 is responsible for controlling access to system objects and processes. The security model is implemented, at its highest level, by authentication (identifying positively by userid and password that you are who you say you are), and by authorization (now that we know who you are, what are you authorized to see?). The authentication is handled by the integrated IAM security manager component. This component can either work with it own data store (see FIG. 13) or other authentication server (such as LDAP). The authorization model is more complex and is based on groups that control what you can see and do. Groups identify the types of activities the user can perform in the application and identify the sets of data on which they can perform those activities. As shown in FIG. 14, an individual may be a member of one or more groups. The security schema also provides for ‘hiding’ data elements dynamically on the screen if your access does not allow you to view them. As shown in FIG. 15, the group level control is implemented through a defined set of access control and processes permissions.

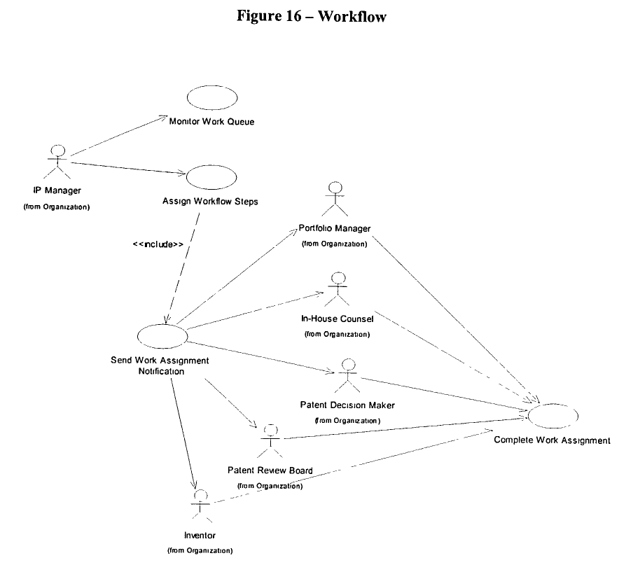

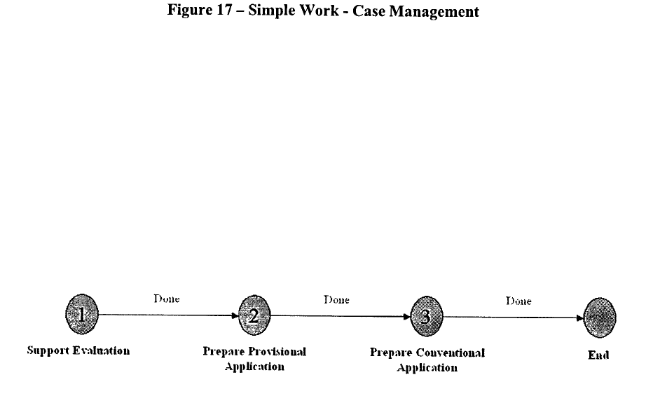

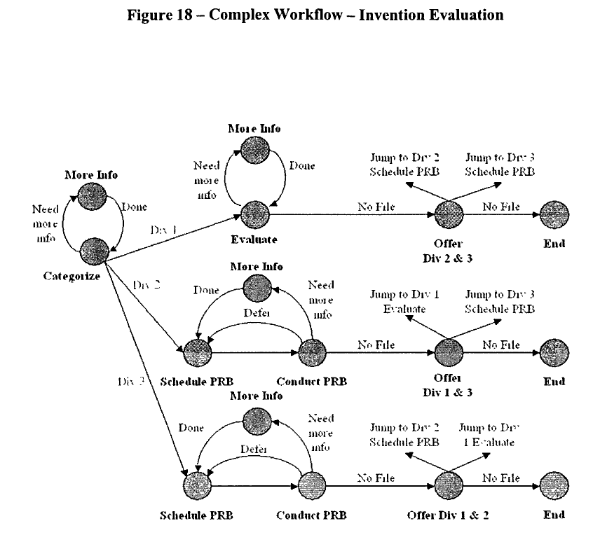

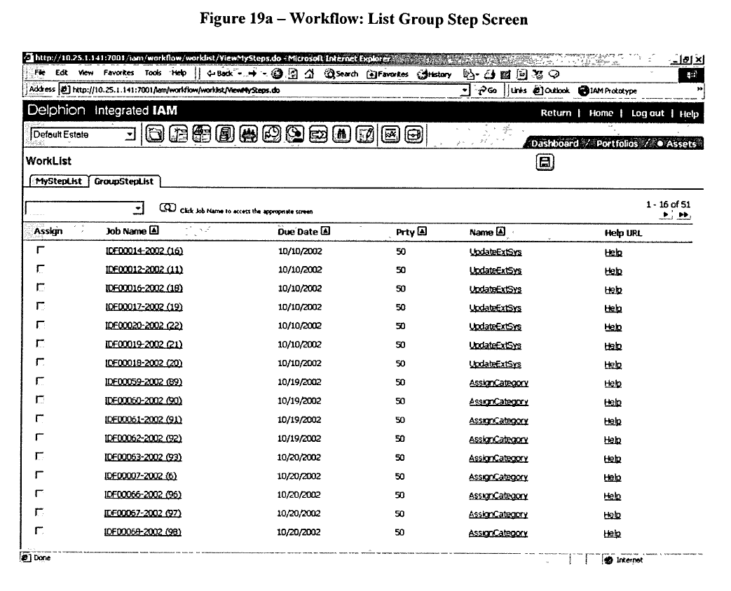

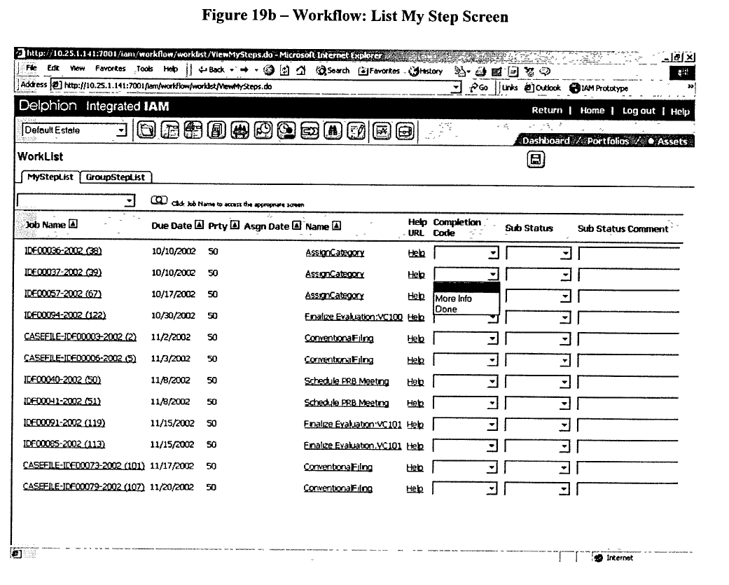

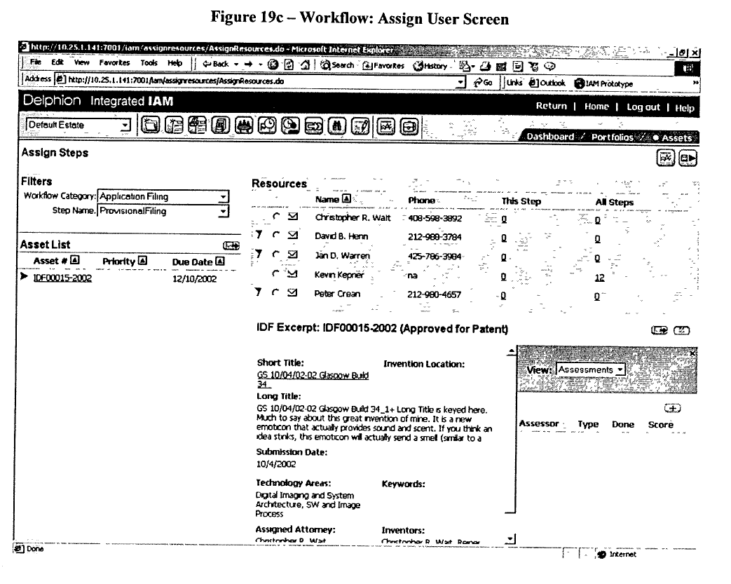

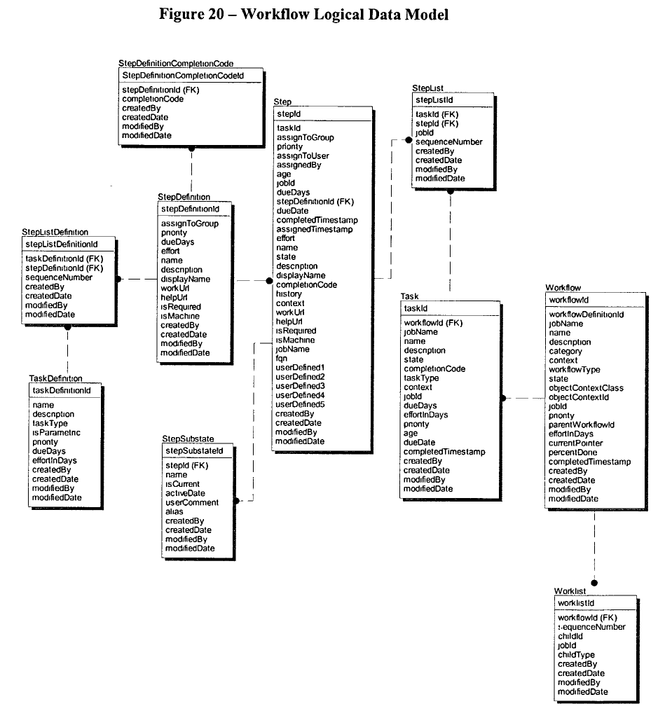

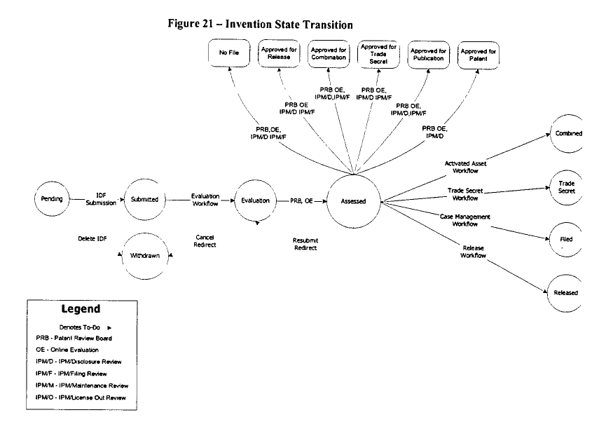

The workflow engine 257 is responsible for the control of business logic and processes within the integrated intellectual asset management system 200 (FIG. 16). The workflow engine is data configurable to allow for the support of either simple (FIG. 17) or complex (FIG. 18) workflows. FIGS. 19a-c show example screens associated with the execution and assignment of workflow steps. To reflect the nature of intellectual property lifecycle activities, the system 200 supports the ability to ‘Jump To’ to any step, either forward or backward, within the process. When a jump occurs, it will ensure appropriate business logic is executed to ensure the correct procedures are being followed for an asset, including maintaining the system state. FIG. 20 shows details of the data that may be stored to configure and control each instance of a workflow within an integrated intellectual asset management system 200. FIG. 21 shows exemplary details of how different states of transition for an invention asset are controlled by the workflow engine 257. All other assets within the system can have workflows configured and controlled in a similar manner.

The rules engine 259 is responsible for building business rules in an ‘english-like’ environment that can then be compiled and used by an integrated intellectual asset management system 200. The rules engine 259 interfaces between elements of the business logic layer 216 and the rules repository in the resource layer 218. The rules engine 259 also services requests from elements in the business logic layer 216, accepting business objects (value objects 252 or packages 253) and invoking the appropriate business rules to update the business objects or provide some response for the business logic layer 216 to use as input for application processing.

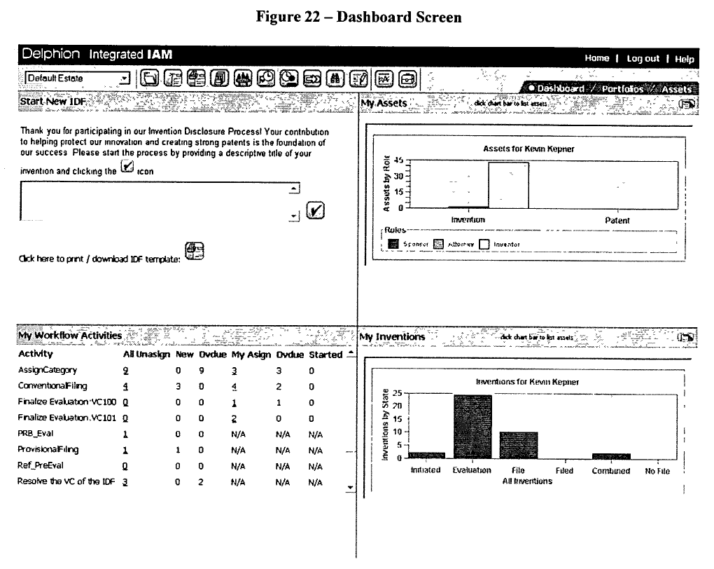

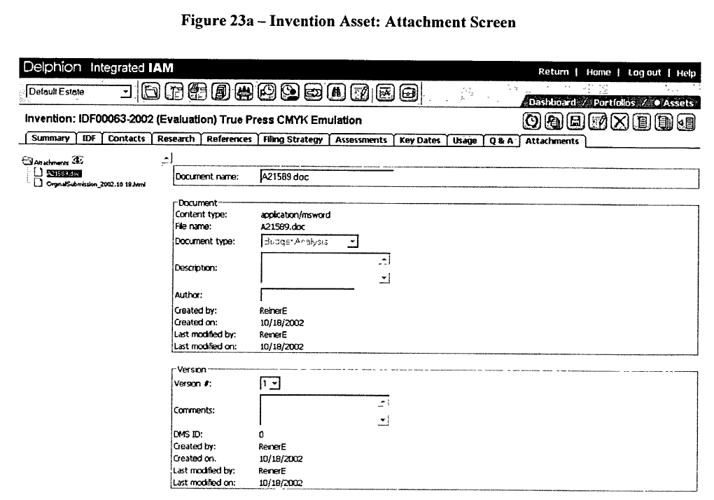

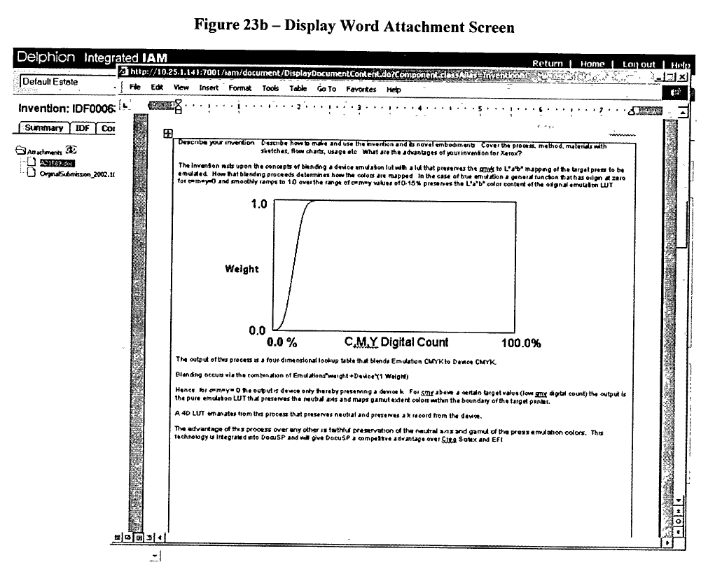

The report engine 258 is responsible for interaction with the report definition to obtain the report data and render the presentation of the report. The chart engine 248 is responsible for rendering application data in graphical and geocentric visualizations of related, pattern and hierarchical data. The chart engine 248 may integrate with an application via delivery as a java bean component that encapsulates the chart engine API. FIG. 12a and FIG. 22 illustrate examples of how the charting engine 248 is used to render complex relationships and broad intellectual property lifecycle metrics in a graphical manner. The document manager 249 encapsulates the document management interface between the business logic layer 216 and the resource layer 218. It is responsible for all document file persistence (get, add, update, delete) operations with the document repository. FIGS. 23a-b show example screens used to attach and view documents.

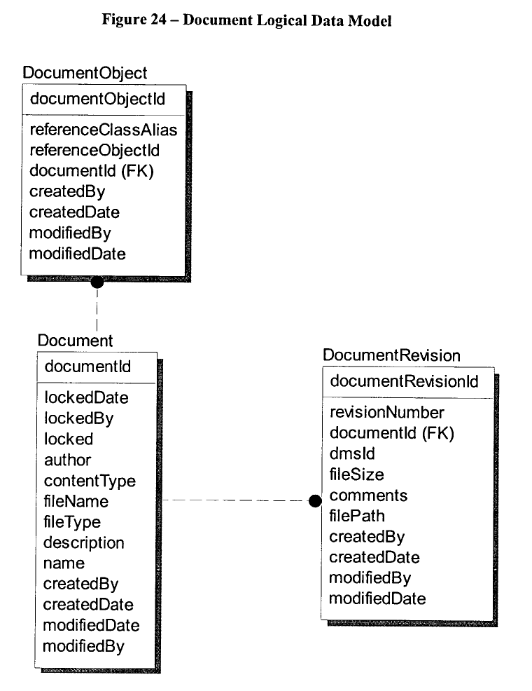

A key capability of the document manager 249 is to store attachments associated with both individual assets, such as inventions or patents, and with higher-level components, such as meetings or portfolios, which represent a higher level grouping of assets. Also, many types of documents and other attachments such as presentations, spreadsheets and CAD drawings can be stored with the document manager 249. To ensure that data is not tampered with, it is maintained on the file system within an encrypted data store. FIG. 24 depicts details of exemplary document data that may be stored within an intellectual asset management system 200 embodiment in addition to the physical document.

### Integration Layer

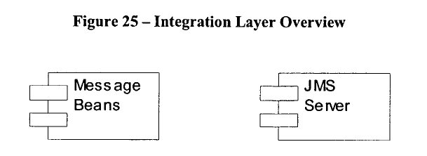

The integration layer 217 provides integration between the business logic layer 216 and external enterprise information systems and legacy systems. In one embodiment, a key design point for an integrated intellectual asset management system's external integration strategy is the use of Java Messaging Services (JMS) and XML. As shown in FIG. 25, in this embodiment, the integrated intellectual asset management system architecture for integration is based on providing systems services (JMS) that will allow the system to send and receive transactions for ‘outside’ systems and to, wherever possible, use XML as the data format/structure.

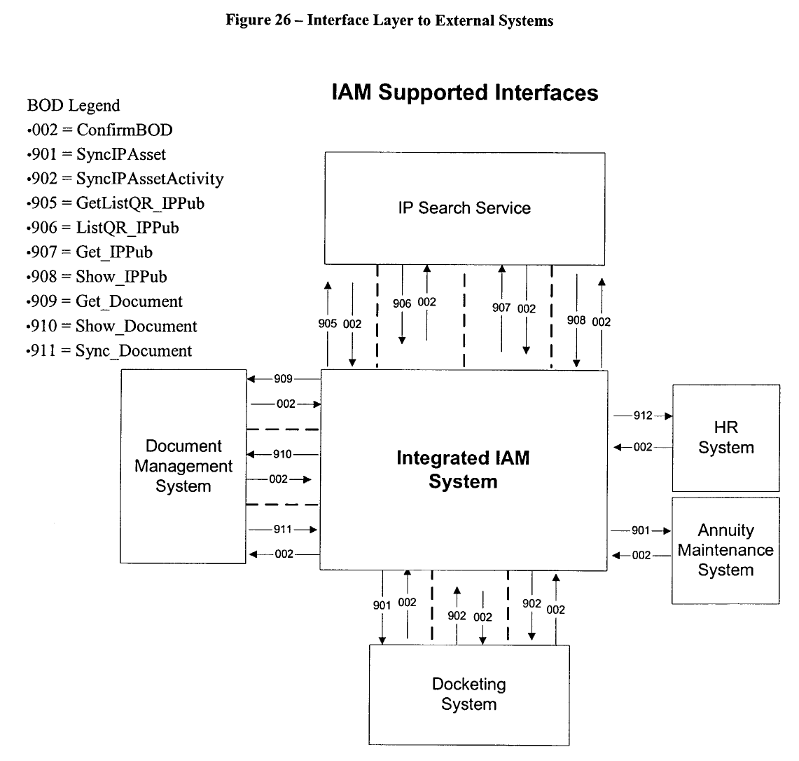

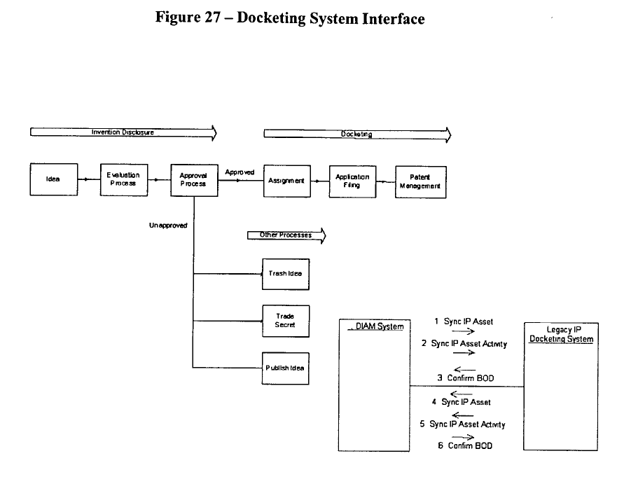

As shown in FIG. 26 and FIG. 27, the integrated intellectual asset management system 200 may interface with an external intellectual property research website, while at the same time, having the capability to also interface with internal systems such as human resources, financial systems, docketing/other intellectual property systems, document management, annuity systems and others.

### Resource Layer

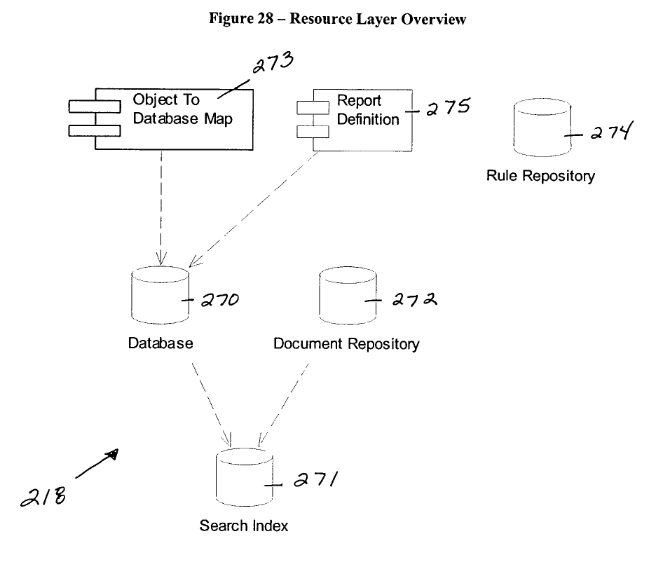

As shown in FIG. 28, the resource layer 218 provides an integration point to the physical storage and file systems on the application and database servers. The resource layer 218 also provides access to rule-sets, notifications and similar back-end resources. The databases 270 contain a persistent data store containing application configuration (security, workflow definition, etc) and operational data (assets, related business objects). The search index 271 provides an index to the database 270 and a document repository 272 for conducting efficient user-defined searches. The object-to-database map 273 provides an extendable framework for mapping the attributes for a business object (Value Object) to specified database table(s) and columns. The object-to-database map 273 further provides a layer of indirection between the business object implementation in the business logic layer 216 and the database implementation in the resource layer 218. The rules repository 274 is a central repository of all application default and customer configured business rules. The rules repository is maintained in the resource layer 218 so that the business rules can be modified and redeployed without changing the application code implemented in the business logic layer 216. The rules repository 274 also provides a management framework for application context sensitive rule sets and individual business rules. The report definition 275 is a template for generating application reports. The report definition 275 includes input argument definitions and embedded SQL for obtaining the selected report data. The document repository 272 is a file-based repository for storing document files that have been associated to application business objects.

### Operation of the Intellectual Asset Management System

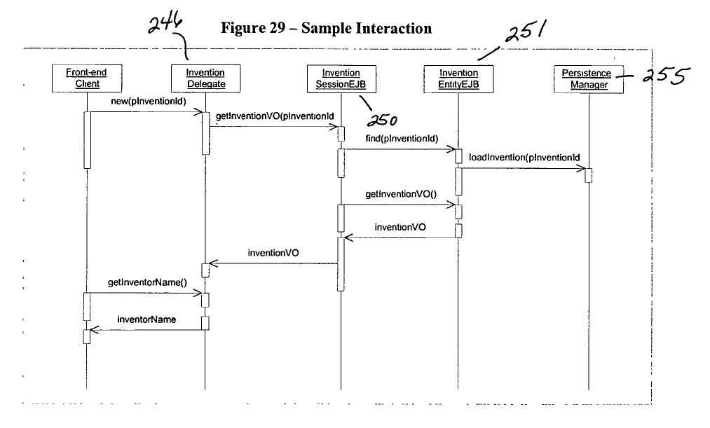

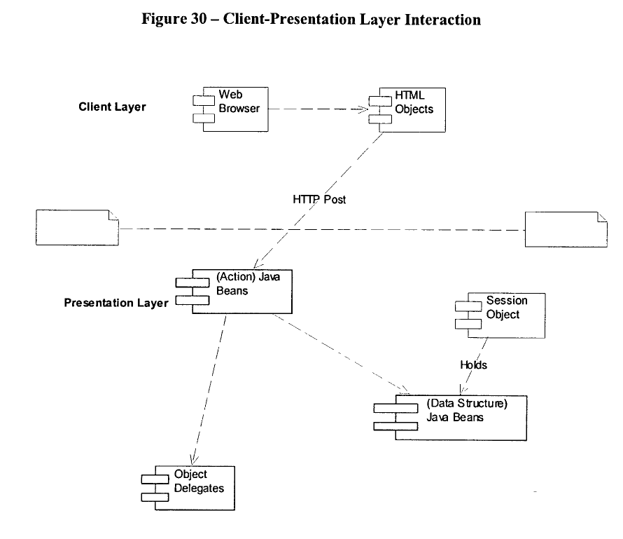

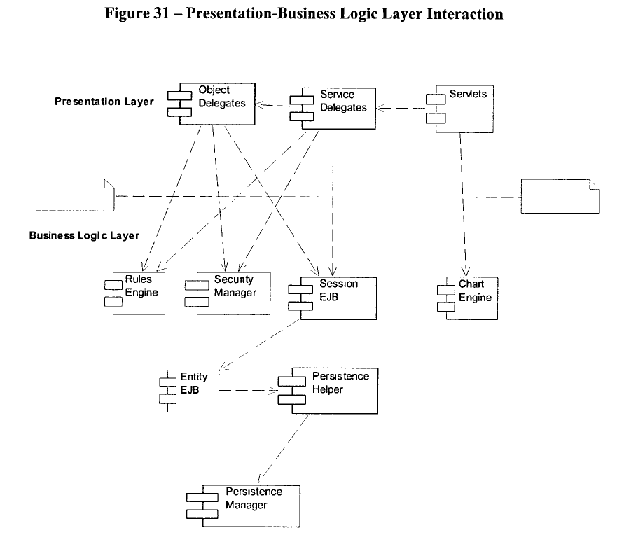

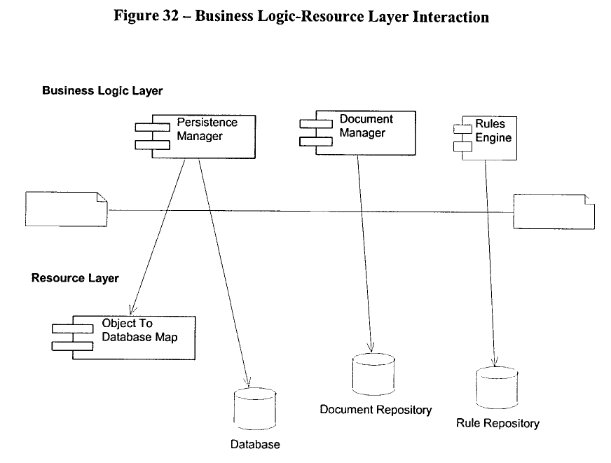

Referring to FIGS. 29-32, an embodiment of an integrated intellectual asset management system architecture calls for the use of Entity EJBs 251 to control access to persistent data (including but not limited to relational database data). A request for data from the client is handled by the appropriate business delegate 246 (or 247), which controls what information is exposed to the client. The business delegate 246 then interacts with the Session EJB 250, which controls/enforces business logic that is/may be associated with the request. The Session EJB 250 then contacts the appropriate Entity EJB 251, which then interacts with a persistence manager 255 to identify if the requested data/information already exists (is persistent) in the environment (cached). Otherwise the Entity EJB 251 interacts directly with the data store to fulfill the request. The Entity EJB 251 fulfills the request using a value object(s) 252, which stores multiple attributes (data elements) in an aggregated fashion to promote efficiency. The value object 252 is then passed back to the Session EJB 250 and is made available to the business delegate 246. The business delegate 246 then makes those attributes (data elements) contained in the value object 252 available to the client. All personalization and security processing and filtering are also being conducted during this process.

Smart value objects may also be part of an integrated intellectual asset management system's data access architecture. Smart value objects provide the ability to dynamically modify the attributes (data elements) being requested, while also allowing the object to contain ‘local’ (operates solely on the values of the attributes in the value object) business logic. The role of the business delegate 246 is to control and manage what attributes are exposed (made available) to the requesting client. Additionally, this architecture also uses the concept of a service delegate 247, which manages and controls requests made of multiple business delegates.

Typically, retrieving a large number of rows of data means that a list of information is being presented to the user, with the user browsing and then selecting a single (or small subset) of the data to perform data manipulation. Performance issues may be associated with accessing large numbers of rows from a database. To minimize any such performance problems, an embodiment of the invention uses a fast lane reader pattern. In this embodiment, the EJB's are bypassed in favor of a Data Access Object (DAO) that handles the client request and makes a direct JDBC (Java Data Base Connectivity) call to the database. The result set is then passed back to the DAO, which returns it to the requester. The upside of the fast lane reader embodiment is speed with a large amount of data. In the integrated intellectual asset management system architecture, the role of the DAO is taken by a custom object that, besides performing the data acquisition management function, also enforces security and personalization functions. When returned the data is stored in a memory array(s) (an ‘array of arrays’) and formatted to promote ease of use when presenting the data to the user.

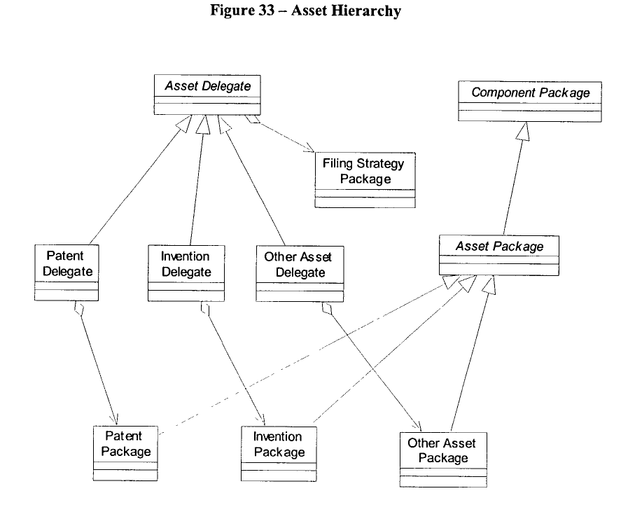

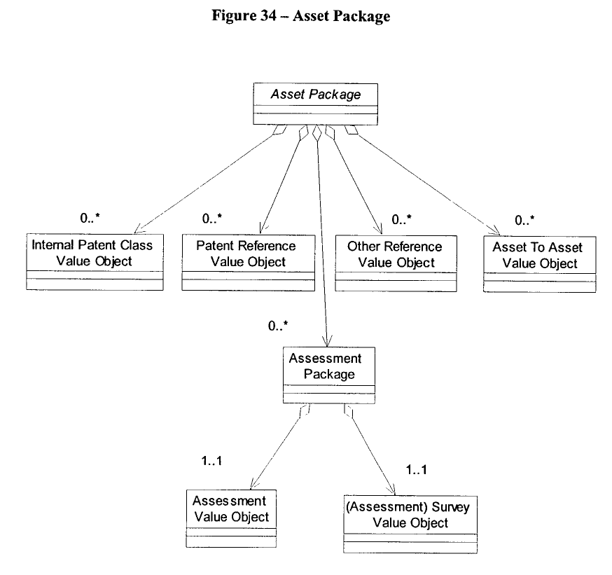

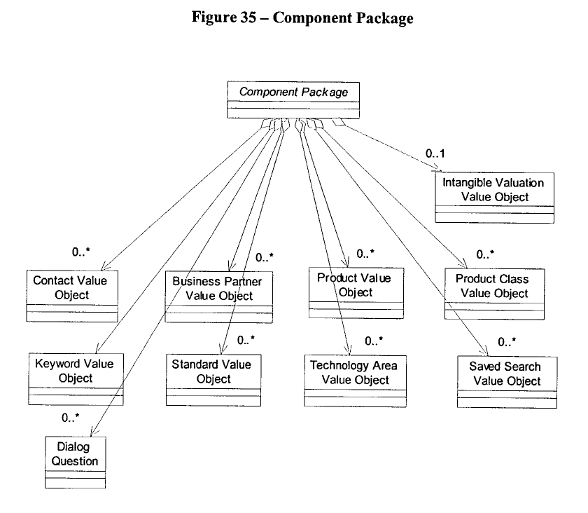

The intellectual asset management system 200 has an asset centric nature. This aspect of the system 200 provides flexibility to the system and allows it to manage many types of assets within a single system while supporting a diverse set of management and control features. Referring to FIG. 33, an asset hierarchy of the intellectual asset management system 200 is illustrated. As shown, the asset delegates and packages are used to provide access to a common set of business services and data storage methods that can be inherited by other asset types, such as inventions, applications, patents, etc. An example of the use this hierarchy is the filing strategy package that is described below. FIG. 34 shows how assets can support asset specific categorization data such as internal patent class, asset references, other references, asset-to-asset relationships and (assessment) Survey. FIG. 35 shows how the component package offers additional data components to the asset object including categorization elements (e.g., product usage details, product class usage details, keywords, technology and standard usages details; supporting information); person contact details, business partner details, intangible valuation, saved searches and Dialog Questions and related answers. Such private intellectual asset management information is used to complement and annotate any public data that is available for the asset, such as published claims for a patent. The categorization data elements allow complex analysis and grouping of assets within the integrated intellectual asset management system.

Asset to asset relationships can be created in the intellectual asset management system 200, either based on manual requests or as the system completes business activities controlled by an asset's workflow, that can be used to provide insight to the interrelations of assets or support business decision associated with a group of assets (i.e. show a main family of patents within the US only. A single invention could create multiple patent applications based on the filing strategy defined for the asset.) Further, defined assets in the system 200 can make use of common services that are available to all assets types. These include document attachments, saved searches, assessments, workflow, questions & answers, notes and other services. Further the use of assets in the integrated intellectual asset management system 200 provides for the capability of not duplicating data that is already available in the public domain. The asset structure of the intellectual asset management system 200 supports the ability to maintain pointers to data in public repositories. This data can also be referenced, annotated with notes at attribute level, used to conduct a claim assessment and categorized to build a private repository of data that can be used to support various business processes within the integrated intellectual asset management system 200. As asset data is displayed, the system supports the ability to display public and private data within the same screen, thus providing a seamless interface to the user without having to duplicate the vast quantity of data in the public domain.

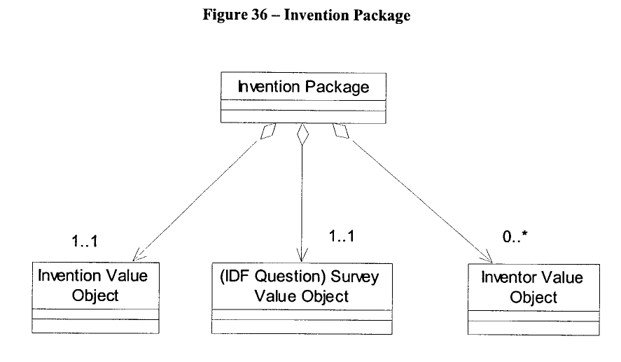

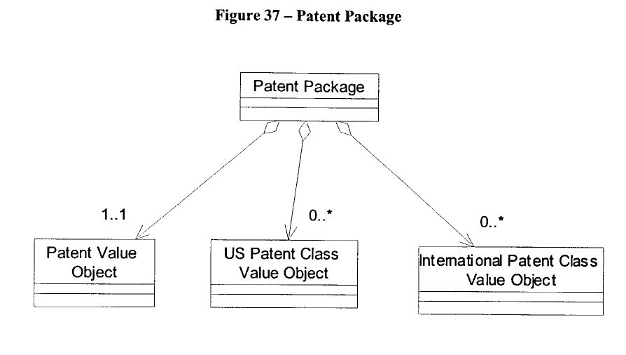

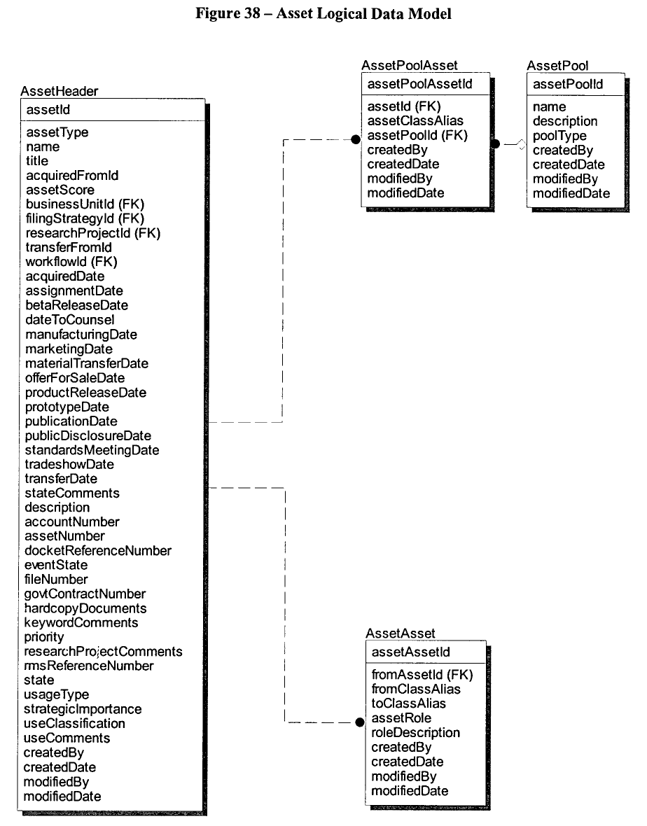

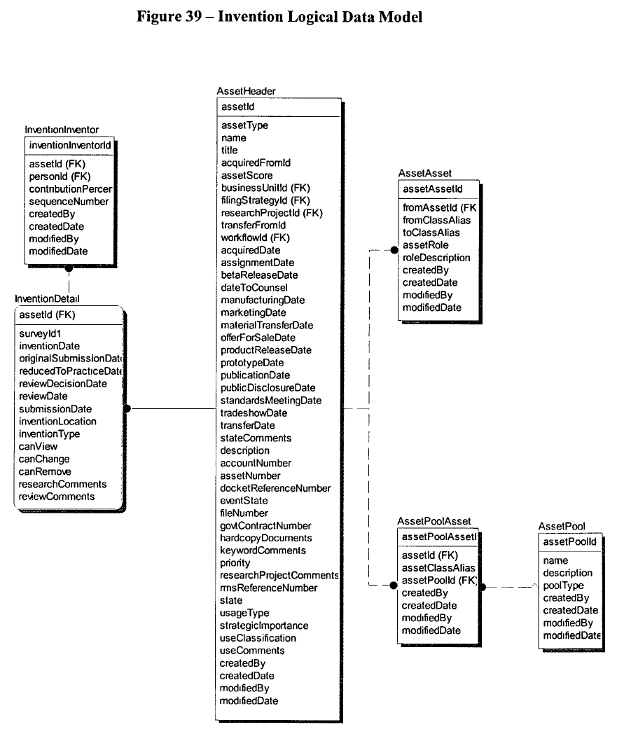

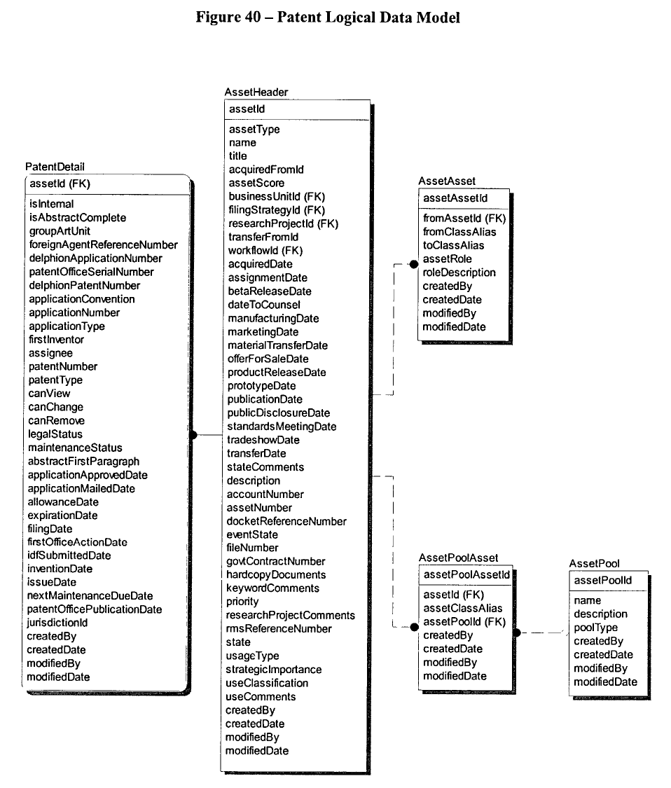

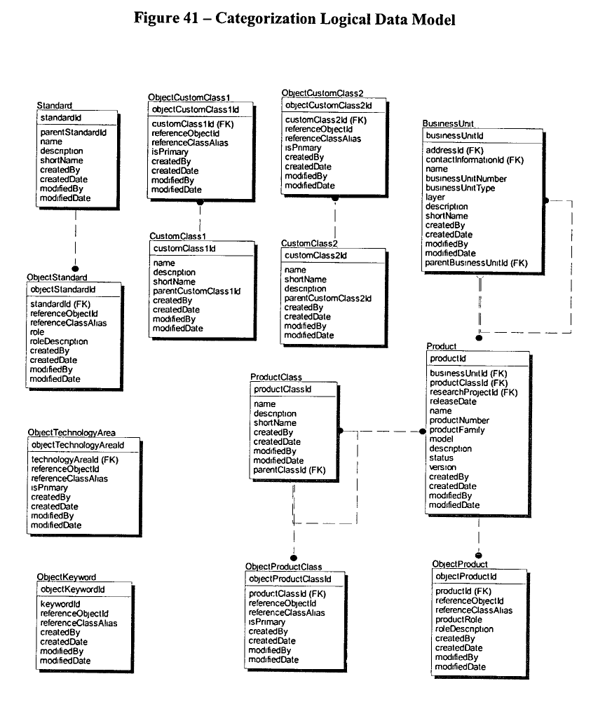

Also, as needed additional asset types can be created within the system 200. These additional asset types such as trade secrets, trademarks, publications, and know how will all inherit the core capabilities supported by the base asset object. Theses additional asset types can implement data and business functions that are specific to the system's needs. FIGS. 36 and 37 show how invention and patent objects may be extended from an asset object. FIGS. 38-40 illustrate exemplary database tables that may be used to store asset data and the extensions required to model an invention or a patent object. All of the assets in the system 200 may use categorization tables similar to those detailed in FIG. 41.

### Filing Strategy

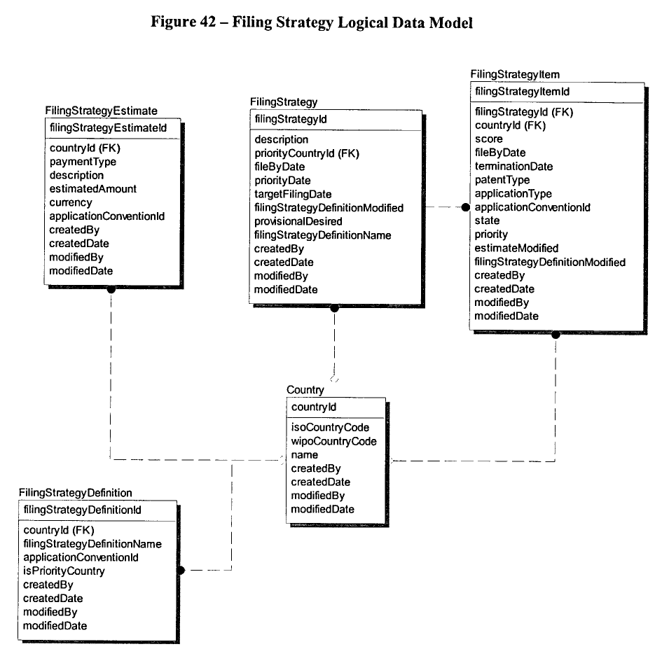

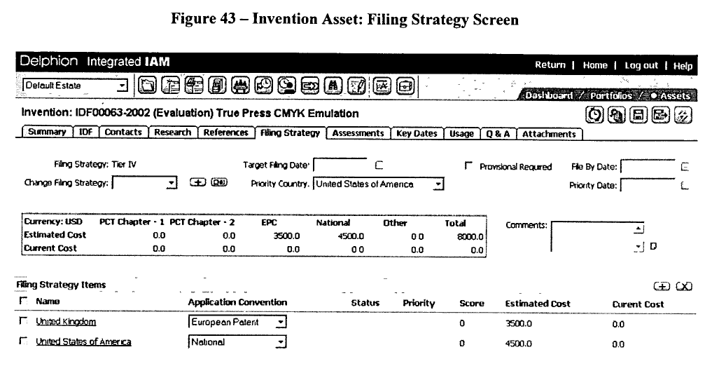

The intellectual asset management system 200 of the present invention supports an organization's filing strategy. A filing strategy is a definition of a plan to file for patent coverage in one or more countries. FIG. 42 illustrates data elements that can be maintained within a strategy definition. A specific instance of a plan can be created from one or more configured templates. As needed, the user can extend or modify the countries that should be included in the plan. This plan may also include estimated costs for what it will cost to file in each country broken down into multiple categories such as filing fees, outside counsel, foreign brokers, etc. A filing strategy may be associated with one or more assets, thus allowing the development of patent application to be coordinated off a single plan for a family of worldwide patents, patent for a new product, etc. As actual costs are incurred, these can also be recorded against the instance of a filing strategy. FIG. 43 shows a sample screen associated with an invention filing strategy.

### Assessments

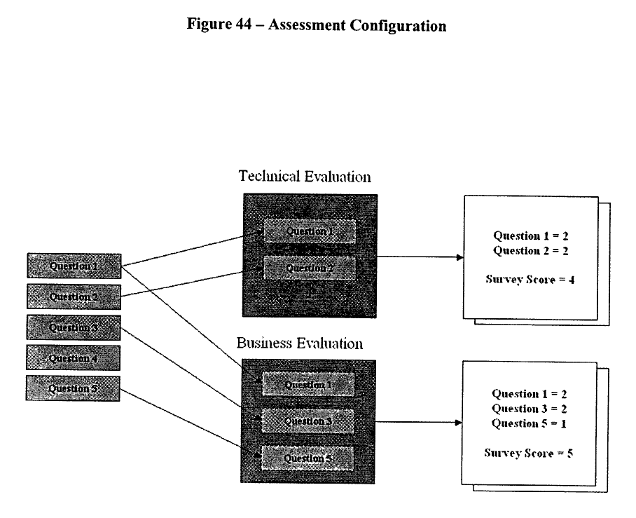

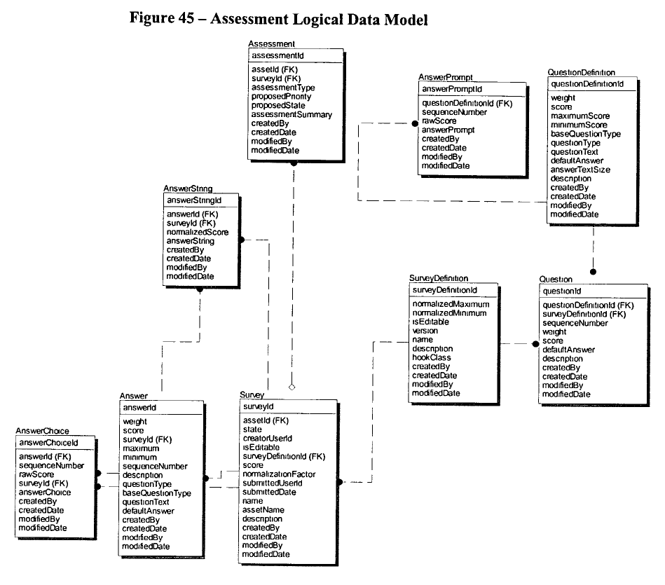

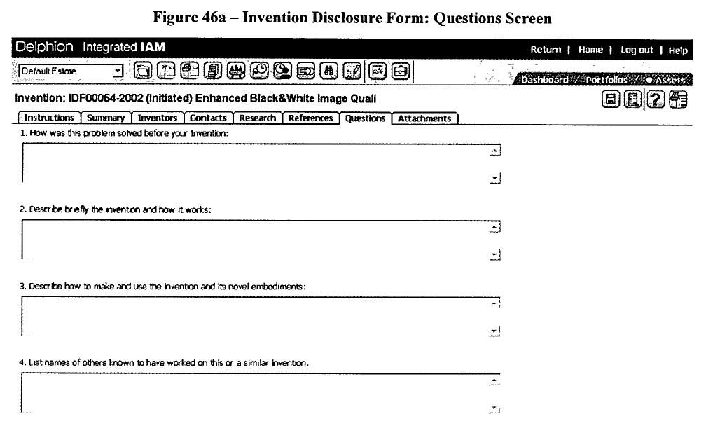

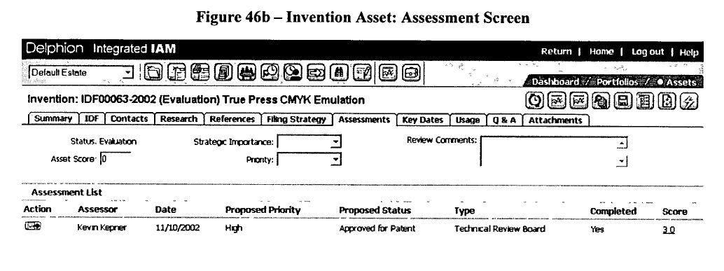

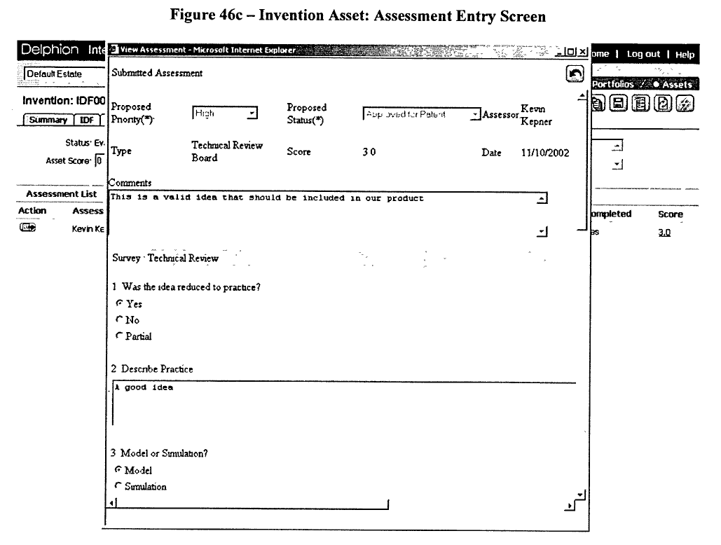

As represented in FIG. 44, an assessment is a configurable survey that allows unique combinations of questions to be asked at various points in the lifecycle of an asset. FIG. 45 shows an example of database tables used to store assessment definitions and specific instances of an assessment. Each survey supports the ability to have different question scoring and weighting logic based on which survey the question is being associated with. By using the rules engine to select a survey definition using attributes of the asset and/or where the asset is in its lifecycle, this capability is used in many ways with the system 200, including invention disclosure form questions to ask inventors; as part of a business, technical or legal review during invention evaluation, maintenance reviews, claims analysis, etc. As an assessment is completed, a specific instance is created that records the answers entered, the calculated score, overall recommendations, etc. Over time, these assessment scores can be trended to detect if the significance of an asset is changing in any way based on changes that are being entered. FIGS. 46a-c show example assessment screens.

### Question & Answers (Dialog)

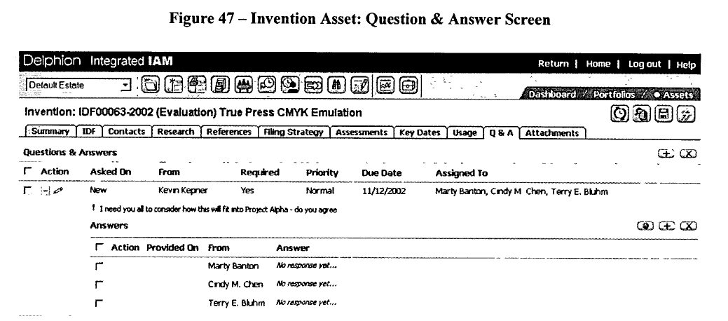

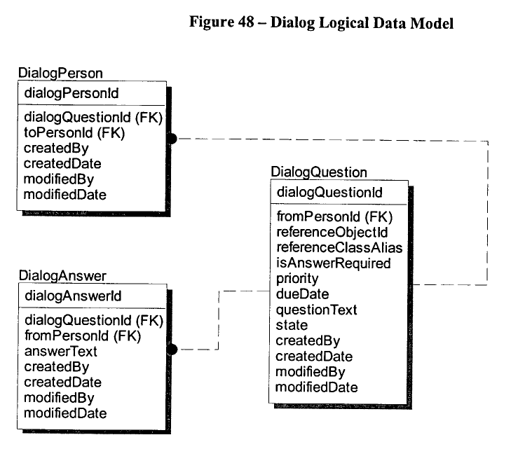

The system 200 of the present invention also supports on-line collaboration between system users. Questions posed during an on-line collaboration session are associated with a specific asset or portfolio. Answers may be recorded against the original question to provide a method to collect ad-hoc discussion associated with business activities being coordinated by the integrated intellectual asset management system 200. FIG. 47 shows an example screen for the Q&A feature. FIG. 48 provides details on the database tables used to store Q&A information.

### Activities, Reminders and Notifications

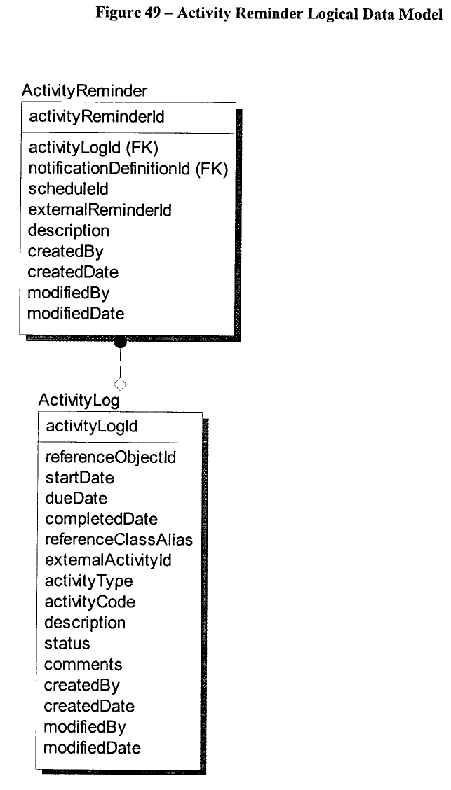

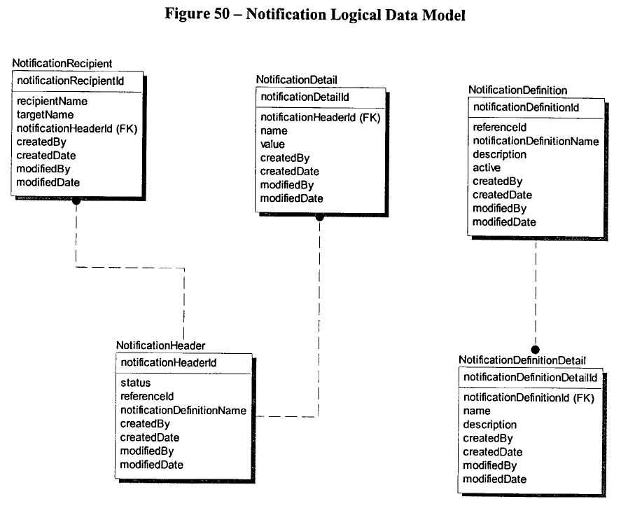

As activities are planned or occur within the integrated intellectual asset management system 200, a log may be kept of these key events. These entries can be triggered either by workflow, manual user entry or events occurring with external systems such as docketing. If the activity is scheduled to occur in the future, it is possible to apply a reminder policy, which will cause the system to proactively issue one or more reminders to one or more users. If necessary, an escalation policy can also be configured for the activity to complement reminders and to ensure a key business event is not missed. When activities occur or when triggered by reminders, the system 200 may use a notification mechanism to inform the required users of the event. This notification service can utilize many methods to inform the user, including pager, email, cell/phone, PDA, FTP, fax and other communications and application formats. FIGS. 49 and 50 illustrate exemplary database tables that may be used to store activities and notification information.

### Folder Management, Workspaces and Dashboards

To support the organization of assets with an integrated intellectual asset management system 200, folder management techniques may be implemented. Folder management provides a hierarchal way of grouping assets into common groups to represent a portfolio of assets. The portfolio can have additional data and business processes associated it. FIGS. 9 and 10 provide examples of portfolio screens. When an asset is placed within a folder, a link is created between the portfolio and asset. Therefore, an asset can be associated with multiple portfolios without having to duplicate data while ensuring all users see the most current information. For large enterprises, it is possible that this folder tree could get very large. Therefore, to control which portions of the tree are available to a user, multiple workspaces may be created that allow branches of the tree to be collected together as if they were the root node for a virtual tree. A user can also create their own workspace to help him or her organize their activities within the system. As required, the user can select which workspace is the active one.

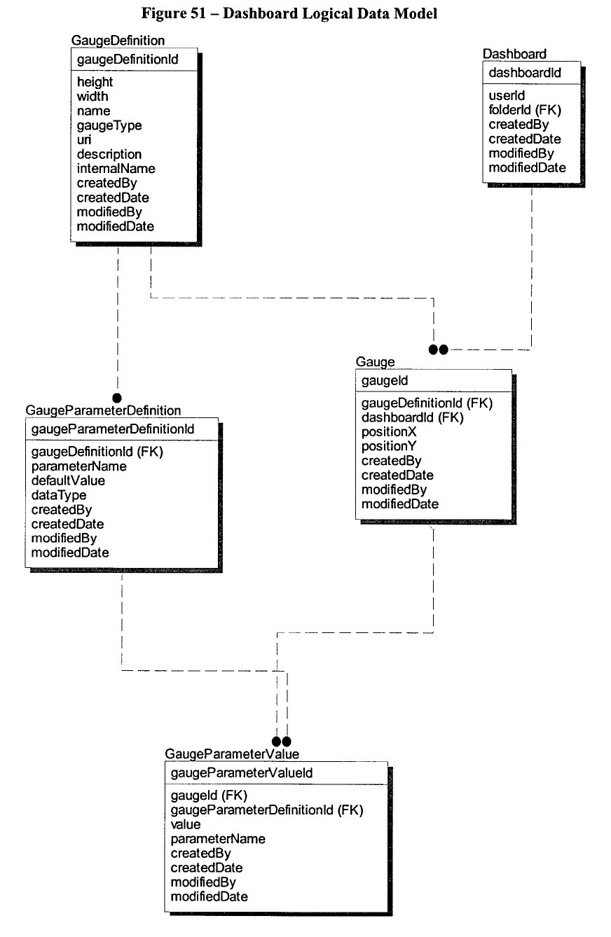

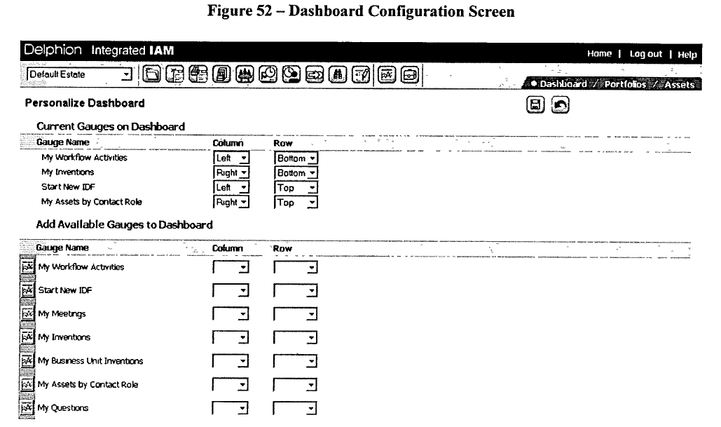

FIG. 22 shows an example dashboard that is associated with a specific workspace. FIG. 51 illustrates exemplary database tables for a dashboard. A dashboard can display multiple gauges that either provide quick access to system data or display high level metrics of key operational parameters associated with intellectual property lifecycle activities. Using the screen shown in FIG. 52, a user can personalize which gauges are displayed and there location on the screen.

### Meeting Management and On-Line Evaluation

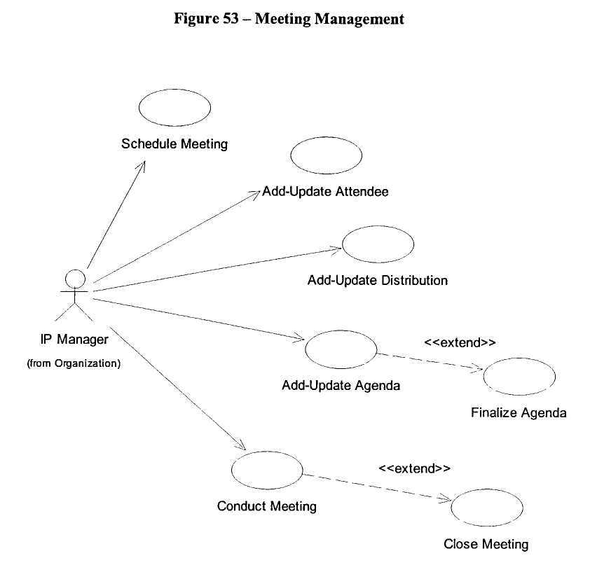

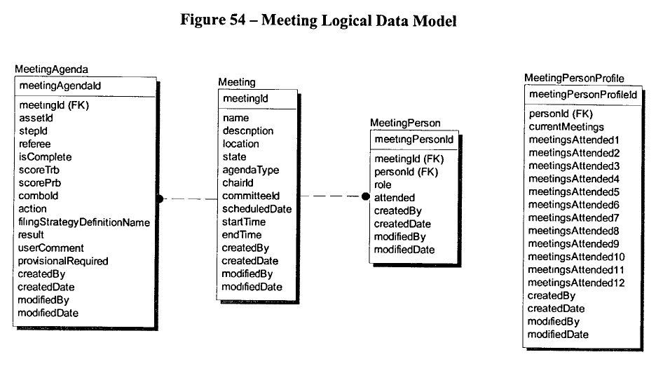

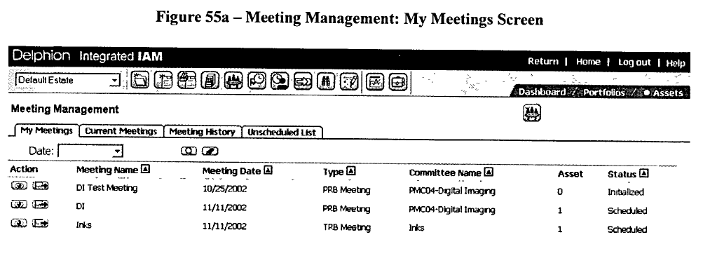

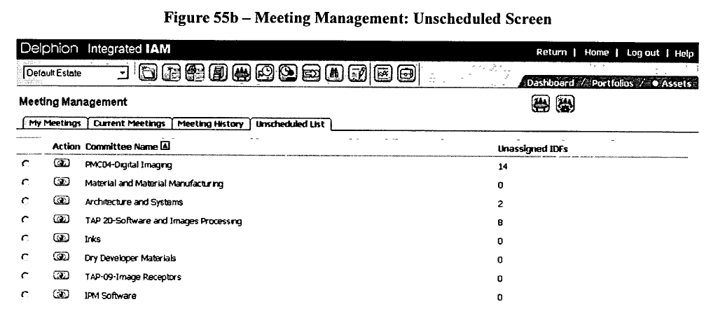

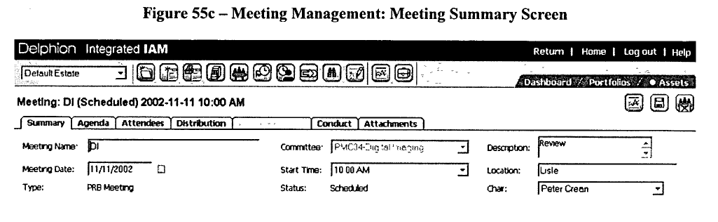

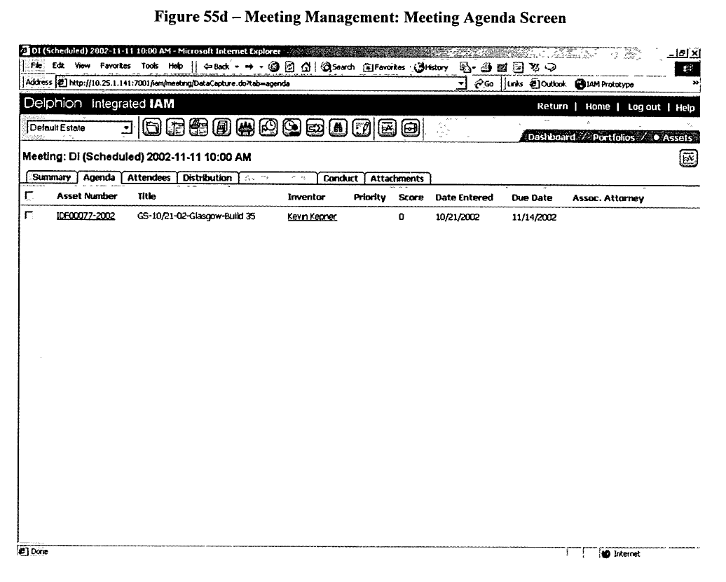

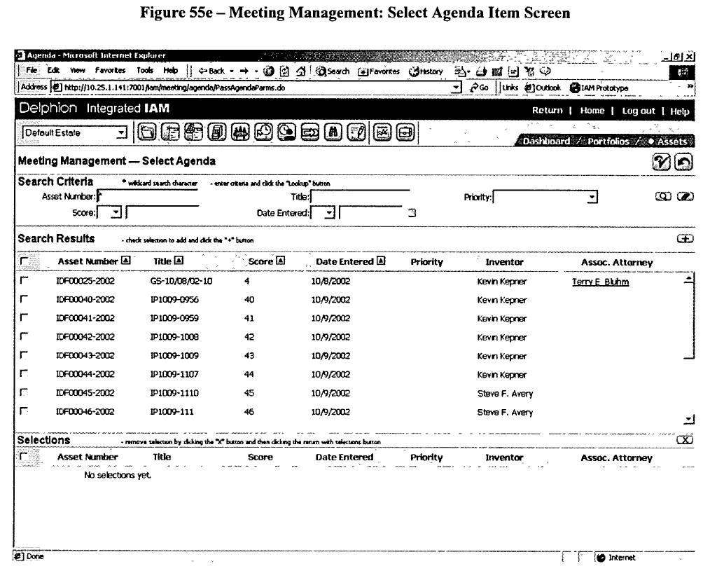

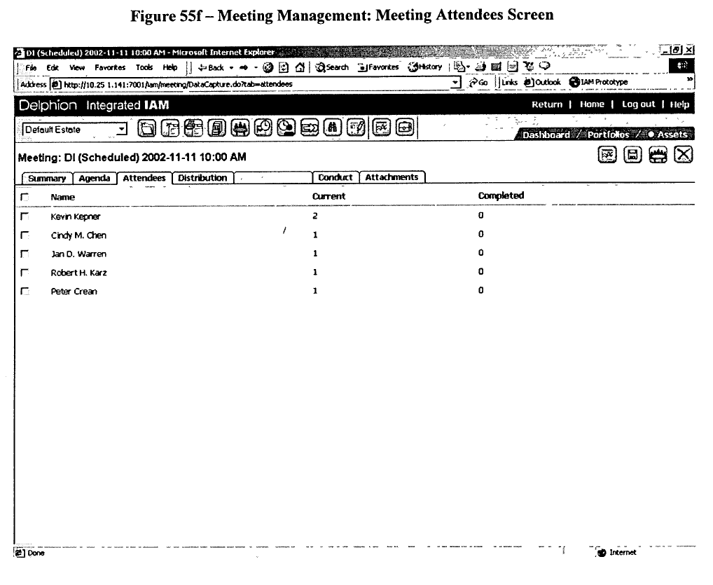

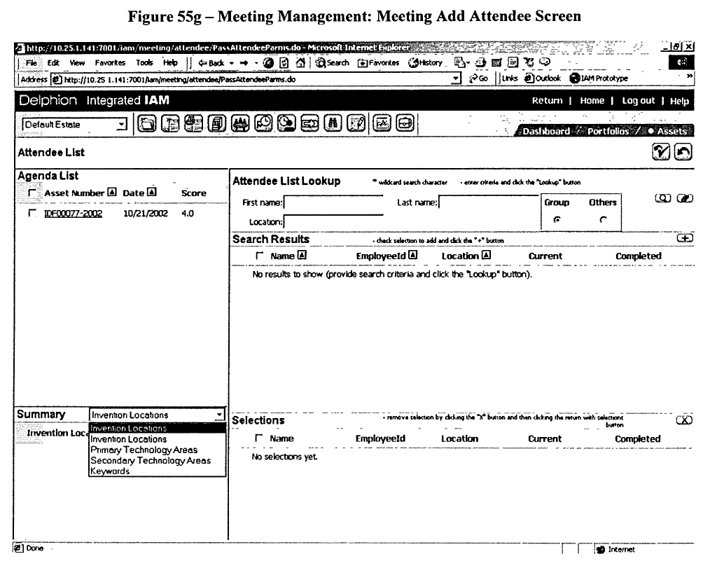

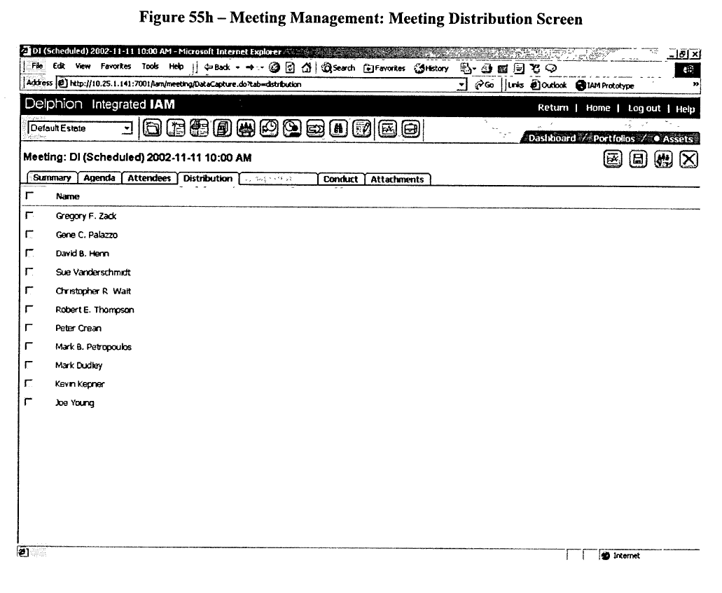

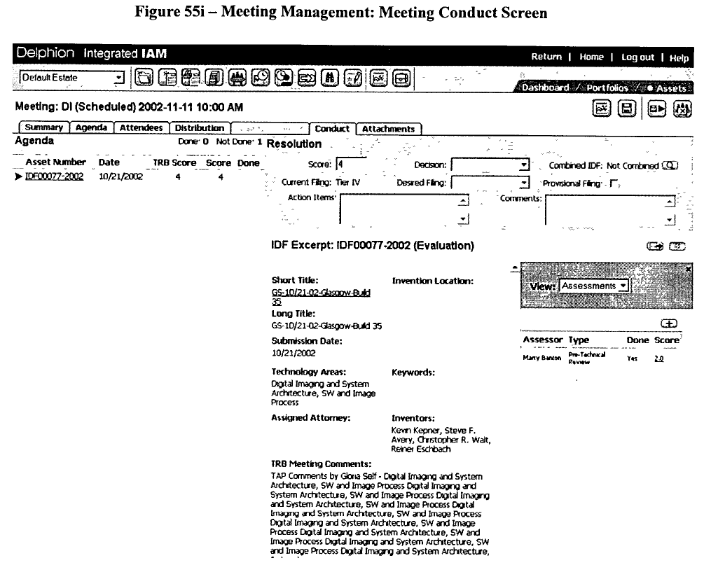

At various points in the lifecycle of an asset, the asset may need to be evaluated in some manner. This includes filing decisions, maintenance reviews, licensing reviews, claims reviews, etc. To allow these evaluations to occur within a coordinated manner, the integrated intellectual asset management system 200 provides the ability to batch assets into groups and schedule them for a formal meeting. FIG. 53 summarizes the features provided by meeting management which include scheduling a meeting, creating attendee or distribution list, adding assets to a meeting agenda, finalizing the meeting prior to notifying attendees, conducting the meeting, recording the results and distributing the meeting minutes once the meeting is closed. It is configurable what type of assets can be added to the agenda by review types for each committee definition. These meeting definitions also support the ability to filter which assets are candidates for the agenda based on asset attributes such as business unit, technology category, etc. FIG. 54 illustrates exemplary database tables used to store meeting information. FIGS. 55a-i depict example screens of the various meeting features supported by an integrated intellectual asset management system 200. When a meeting is closed, an associated workflow for the asset may progress based on the decisions made at the meeting (i.e. if a filing decision was ‘Do Not file’, the invention workflow will end at this point. However, if the decision was ‘File’, a case management workflow will be created for the invention. An alternative to batching assets for a meeting is to perform an on-line review of an individual asset. This is done by assigning reviewers who are prompted by the system 200 to review a specific asset. The reviewers responses are consolidated and presented to an authorized user to record the final decision against the asset. Either within meetings or during on-line reviews, it is possible to send questions to a user on an as-need basis.

### Searching

The integrated intellectual asset management system 200 supports the ability to conduct full-text searching of data stored either within its databases, document repositories or other local data stores. As shown in 56, the system 200 may have a configurable gateway to retrieve data from different data sources (for example databases, XML, Word or PDF documents). This searching capability supports a complex search syntax similar in nature to most web based search engines. Full-text searching may be configured to use one index per data type (invention, patent, trade mark, asset, portfolio, Q&A, note, document, etc). Multiple indices can be searched at the same time, and the result set will contain references to different document types in that case. The benefit of having multiple indices is that each index is smaller, can be indexed in parallel and changing the configuration of one index type (for example, adding a new field) does not require re-indexing all the data.

The combination of the object type plus the object id allows for better indexing. Use of object id by itself is only unique for certain types of data. The object type and object id, in one embodiment, are typically stored as two separate fields (named ‘type’ and ‘id’). Once a user has done a search, the hit list results can be used in many ways including selecting an entry to view the asset details, adding selected assets as references to another asset, inserting assets into a portfolio or saving the search string against an asset or portfolio for future use.

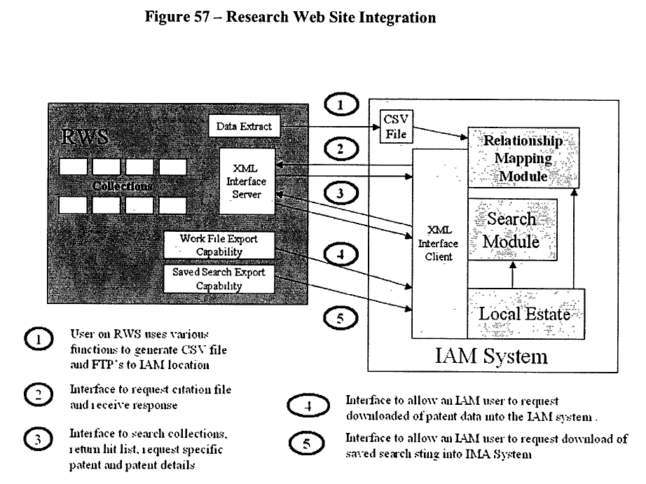

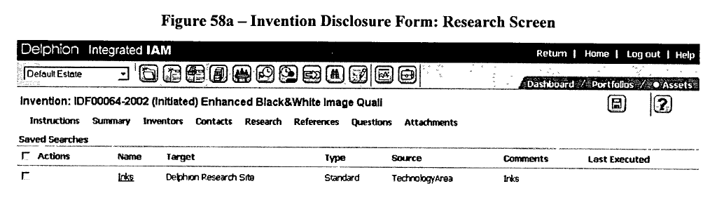

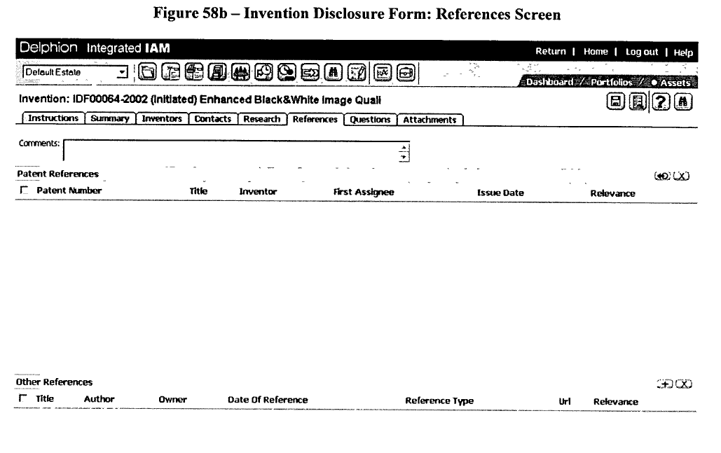

Similar searching capabilities are supported with an Internet based research web site. FIG. 57 shows details of a transaction that support integration with a remote application. FIGS. 12f-j and FIGS. 58a-b depict example screens generated with the various search options available within an embodiment of an integrated intellectual asset management system 200.

### Relationship Mapping Application

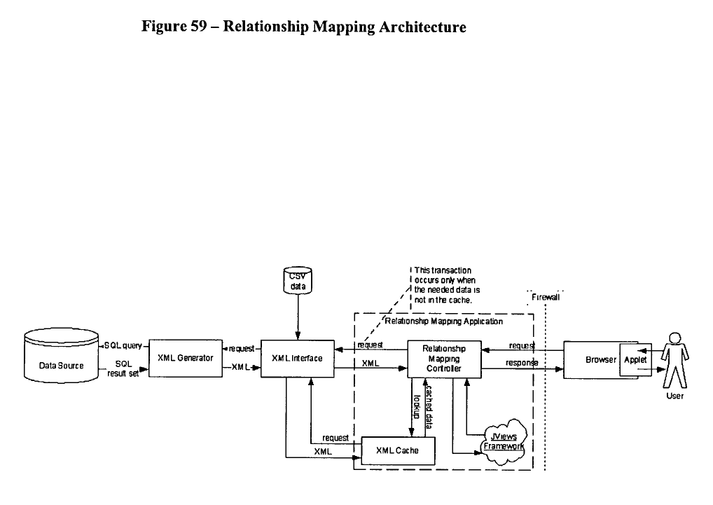

A relationship mapping application (“RMA”) component of an integrated intellectual asset management system 200 supports the visualization of the asset information within the system or from an external research web site. FIG. 59 depicts a relationship mapping application architecture that may be used to support integration with a data source. The chart types that may be supported may include patent citation or timeline views driven via published patent date or specialized charts that use asset categorization data maintained within the integrated intellectual asset management system 200. FIGS. 12a-e depict example screens for the relationship mapping application component.

### Example User Scenarios

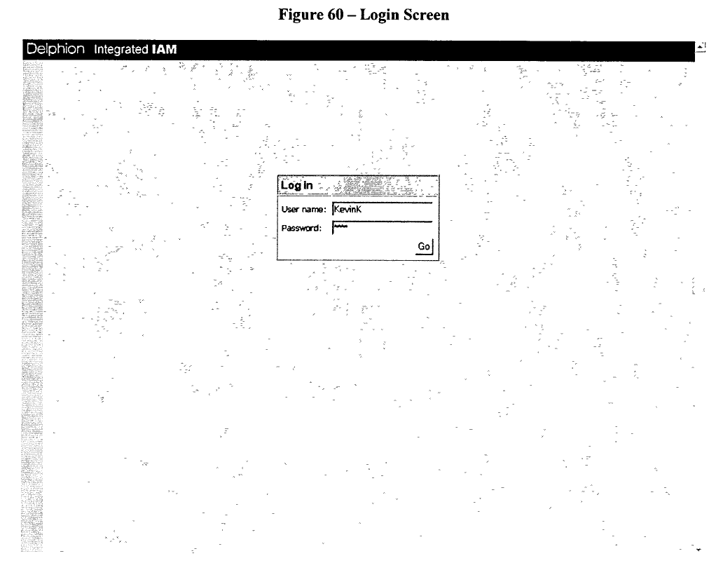

In an embodiment, prior to using any feature within the system 200, a user must log onto the system 200 through a login screen, as depicted in FIG. 60, provided by the security manager.

### Invention to Patent Lifecycle

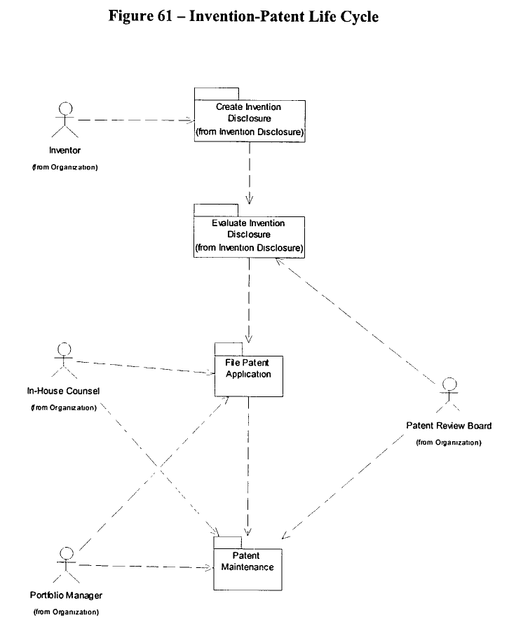

FIG. 61 shows key activities involved in the progression of an idea through the evaluation process as an invention, filing it as a patent application and maintaining it as a granted patent.

### Create Invention Disclosure

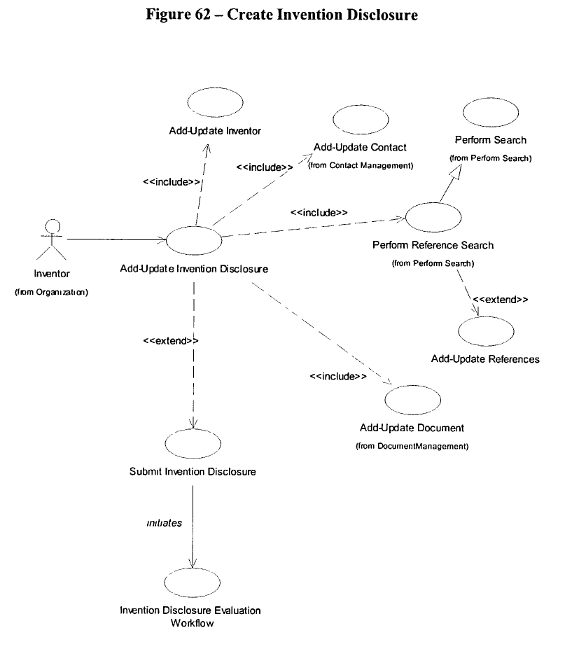

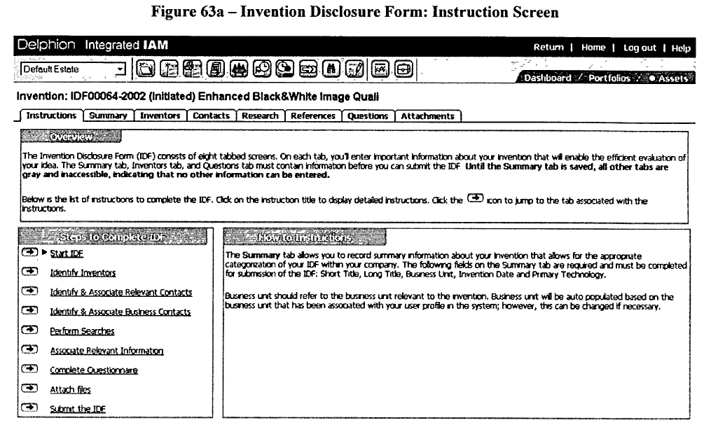

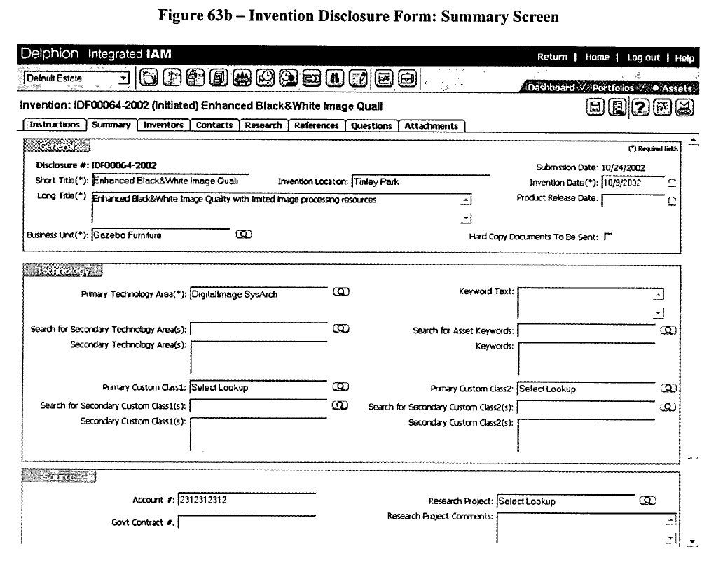

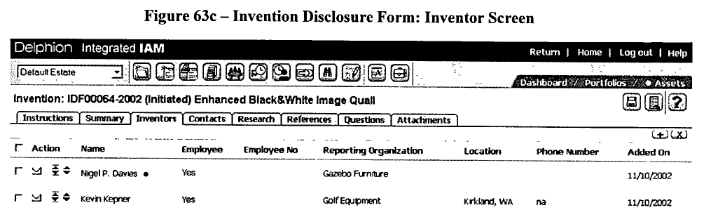

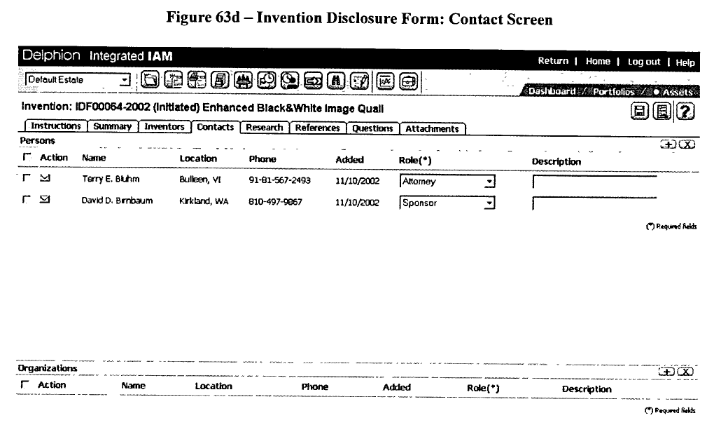

FIG. 62 shows the activities involved in creating an invention disclosure in an embodiment of the invention. Once the user has logged into the system via the security manager, the system user, typically the inventor, may select to create a new invention disclosure. Using screens similar to the ones depicted in FIGS. 46a, 58a-58b, 63a-63d and FIGS. 12f-j, the system user inputs the required invention attributes. These attributes may include asset categorization attributes including primary technology, secondary technologies, research projects, keywords, etc. The system creates an asset instance for an invention type asset. This becomes the parent asset for all assets that are created in future processes for this idea.

When complete, the system user saves the new invention disclosure. The application passes the created invention package to the rules engine and identifies the appropriate survey definition to be used to capture invention disclosure form questions. The application creates a survey instance for the invention disclosure forms questions generated based on the survey definition provided by the rules engine. In response, the system user may then typically identify the inventors of the invention; perform a reference search; identify local asset or patent references using the local and remote search features of the system. The system user can also associate non-patent references at this time. The system user can also identify contacts; answer specific invention disclosure form questions and attach document files (drawings, design specifications, etc) using the document management feature of the system. The system user repeats these steps as required. Multiple inventors may collaborate informally to complete the invention disclosure.

When done, the system user ‘submits’ the completed Invention Disclosure for evaluation. The application passes the invention Package to the rules Engine and identifies the workflow definition to be used to perform the evaluation of the invention disclosure. The application creates an evaluation workflow instance based on the workflow definition provided by the rules engine.

### Evaluation of an Invention Disclosure

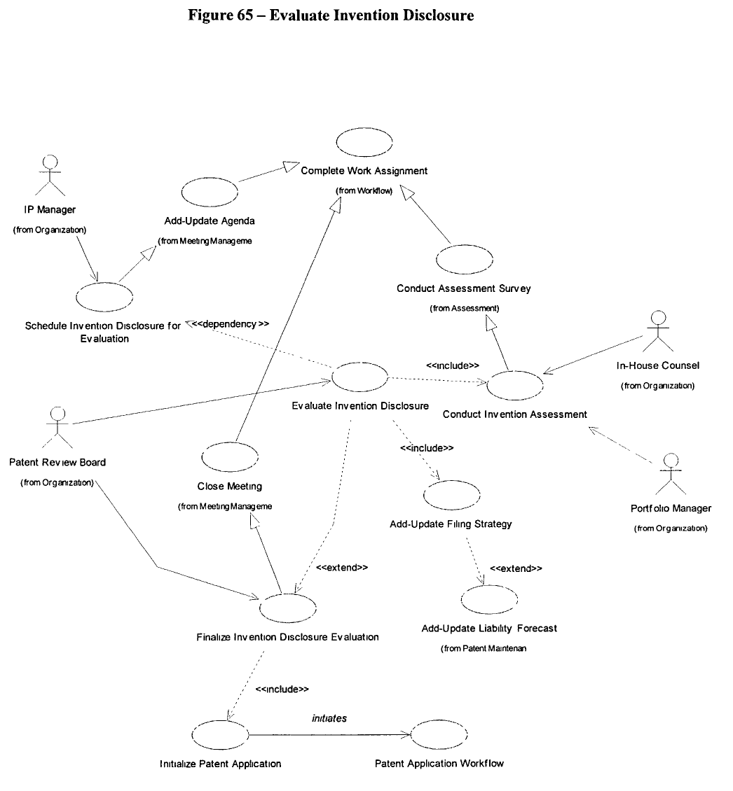

In one embodiment, the system 200 generates screens similar to the ones depicted in FIGS. 22, 43, 46b-c, 47, 23a-b, 55a-l, 64a-c and others if necessary to allow intellectual property Managers (“IP Managers”) and other assigned reviewers within the organization to evaluate a new invention disclosure. FIG. 65 shows the activities that may be involved in evaluating an invention disclosure. In this process, the IP Manager monitors the workflow queue to identify new invention disclosures that require evaluation. IP Managers may also be sent a notification when a new invention is submitted. The IP Manager may schedule a new invention disclosure for evaluation by adding the invention disclosure as an agenda item on a new or existing Patent Review Board meeting. This is done using the meeting management capabilities of the system. An alternative to reviewing disclosures in batch at a meeting is to use the on-line evaluation capabilities of the system to review invention assets one at a time.

With a disclosure review meeting scheduled, the Patent Review Board may conduct the meeting. At the meeting, the Patent Review Board may evaluate each invention disclosure listed as an agenda Item. The Patent Review Board may conduct one or more types of invention assessments (business, legal, technical). As part of the assessment process, the application passes the specified invention package and the selected assessment type (business, legal, technical) to the rules engine and identifies the survey definition to be used for the assessment. The application creates a survey instance for the assessment based on the survey definition provided by the rules engine. The Patent Review Board then completes the assessment survey.

If required a request can be sent to a reviewer prior to the meeting to complete a pre-assessment. When completing an assessment, the reviewer or the attendees of the meeting can view the invention asset, viewing attachments using the document manager and search for similar ideas using the local and remote searching capabilities.

If required, the reviewers can use the question and answer feature to request clarifications from the inventors or seek advice from a peer.

Once a review has been requested or a question sent, a reminder to complete the task can either be manually requested or the system will generate a reminder automatically based on the due date of the task.

Once the assessment is completed the system may calculate an assessment score.

As part of the assessment, the Patent Review Board may identify the desired patent filing strategy for the invention disclosure. The Patent Review Board may identify one or more countries where patent protection is desired and what patent convention (PCT, EP, National) is to be used for each country. Identification of country/convention information allows the system to make a liability forecast calculation of future filing and maintenance costs for each patent application that may be created from the invention disclosure. At the meeting, the Patent Review Board determines the final disposition of the invention disclosure (file the patent application, do not file, other).

At the close of the disclosure review meeting, the application applies the evaluation decision selected by the Patent Review Board to each invention disclosure listed as an agenda Item. This completes the invention disclosure evaluation workflow. If the Patent Review Board decision is to proceed with a patent application filing, the application initializes a patent application object derived from the invention disclosure object. This new asset is created with an asset to asset relationship to the original invention asset. Through this linkage, this application asset and any subsequent application assets created will share attributes. The application then initiates a patent application workflow.

### Patent Application Management

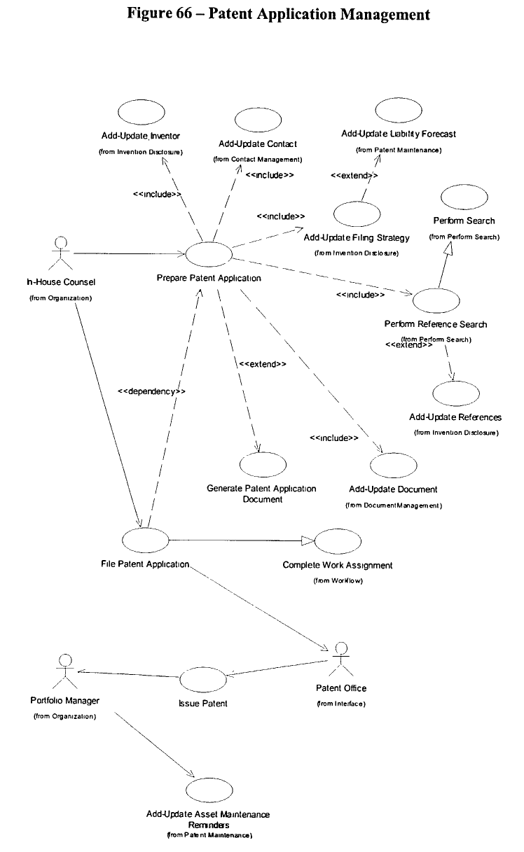

FIG. 66 shows the activities that may be involved in managing the patent application process. In one embodiment, the system 200 generates screens similar to the ones depicted in FIG. 22 and FIGS. 19a-c and others if necessary to allow IP Managers and assigned attorneys to prepare patent applications. The IP Manager monitors the workflow queue to identify new patent applications approved for filing. Also a notification may be sent when the filing of a patent application is approved. The IP Manager may then assign the patent application, through the File Patent Application workflow step, to an attorney using the workload management and resource assignment feature of the system 200. At that point, the attorney prepares the patent application. The attorney updates the inventor information if required. The attorney may perform reference searches using the local and remote search features of the system. The attorney may update patent and non-patent references if required. The attorney may identify contacts. The attorney may attach document files (drawings, detail specifications, legal correspondence, etc.) through the system 200. The attorney may update the filing strategy to reflect any changes in the desired country/convention categories.

At that point, the attorney may generate the patent application document. The system 200 may be set up to send automatic reminders prior to case due dates. The attorney may then file the patent application document with the appropriate Patent Office. At a later date the application asset will be published by the relevant patent office. At that time, the published asset can be downloaded from a remote site and associated with any other asset in system belonging to the invention family.

If successful and a patent is granted, this can also be downloaded as another asset within the system.

Using the asset to asset relationship capabilities of the system, it is possible to maintain a clear understanding of which inventions are associated with which applications (by country) and issued patents (by country).

### Patent Maintenance Management

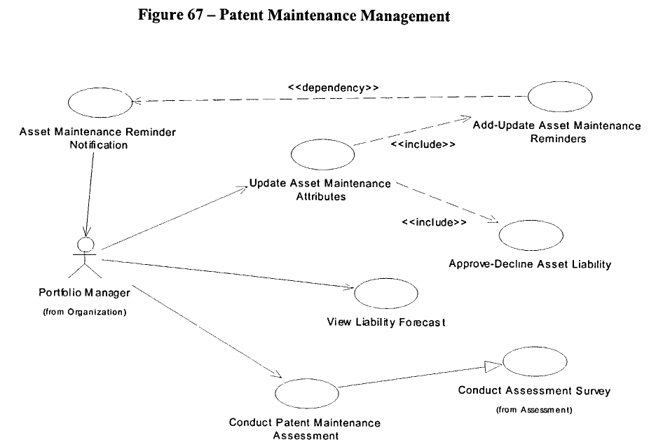

FIG. 67 shows the activities that may be involved in managing the patent maintenance process. Using screens similar to those already described, the Portfolio Manager manages the maintenance of an organization's patent portfolio. The Portfolio Manager may be notified by the system 200 to perform patent maintenance based on an asset liability anniversary date and other legal/business considerations. For time to time, the Portfolio Manager conducts a patent maintenance assessment. As such times, the application passes a patent package to the rules engine and identifies the survey definition to be used for the assessment. The application creates a survey instance for the assessment based on the survey definition provided by the rules engine. The Portfolio Manager then completes the assessment survey. As required, the Portfolio Manager can use the categorization and usage information for the patent to assist in making his decisions. This information can include which products, product classes and standards the patent is associated with. The system application calculates a maintenance score based on the Portfolio Managers answer to the survey questions.

The Portfolio Manager may also review the upcoming maintenance payments. Using the system, the Portfolio Manager may accept or decline to make asset maintenance payments. The Portfolio Manager is usually responsible for updating the patent to designate the maintain/do not maintain status. Using the asset to asset relationships associated with the patent, it is possible to set the maintenance decision for a complete family of patents.

### Conflict and Assertion Management

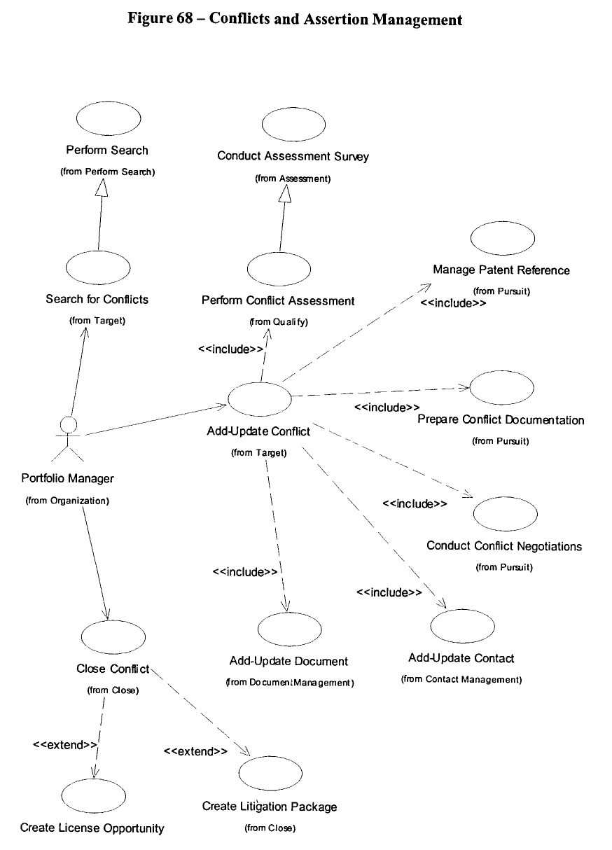

FIG. 68 shows the activities that may be involved in managing conflicts and assertions within an organization. Using screens similar to those already described, a Portfolio Manager may use the system 200 to perform the following tasks to manage conflicts or assertions. The Portfolio Manager may search for Conflicts. The Portfolio Manager may create a new Conflicts asset. In this regard, the Portfolio Manager may complete a Conflicts profile. The Portfolio Manager may also conduct a Conflicts Assessment. The system application may pass a conflict package to the rules engine and identify the survey definition to be used for the assessment. The application may create a survey instance for the assessment based on the survey definition provided by the rules engine. The Portfolio Manager may complete the assessment survey. Once the assessment is completed, the application calculates a conflict score.

The Portfolio Manager may use the system to identify assets (patents, etc.) related to the Conflict. These assets can be either assets of the organization's or a competitor's. Any associations or reference citations can be identified using the Relationship Mapping Applications which searches both local and remote data sources.

The Portfolio Manager may use the system to prepare documentation information related to the Conflict (Product Test, Royalty Model, Claims Chart, Proof Package). The Portfolio Manager may use the system to document Conflict negotiations; identify contacts and attach necessary document files (product specs, revenue forecasts, etc.).

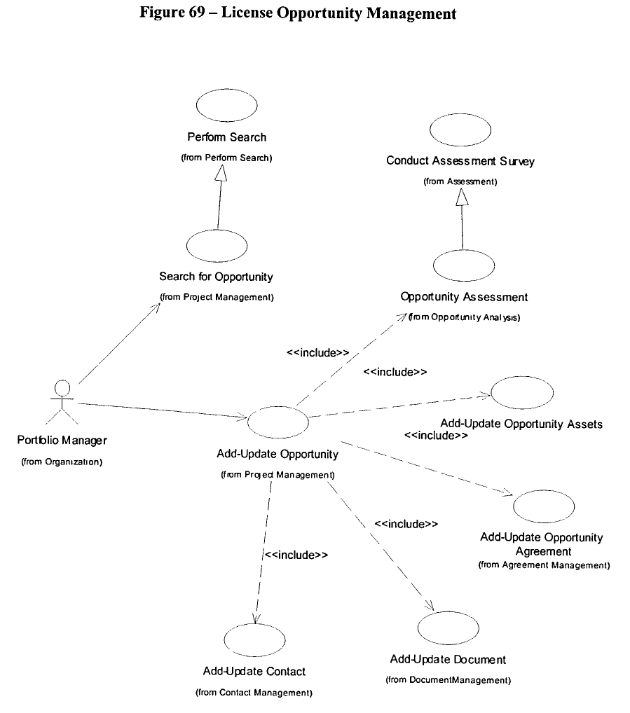

In one embodiment, when a conflict is resolved, the Portfolio Manager may close the Conflict with one of the following: create a license opportunity asset from the conflict profile (FIG. 69) or create a litigation package.

While the invention has been discussed in terms of preferred and specific embodiments, it should be appreciated by those of skill in the art that the invention is not so limited. The embodiments are explained herein by way of example, and there are numerous modifications, variations and other embodiments that may be employed that would still be within the scope of the present invention.

What is claimed is:

1. An intellectual asset management system, comprising:
a computer having intellectual asset management instructions loaded thereon and a database, wherein when the intellectual asset management instructions are activated;
the intellectual asset management instructions capture data regarding an item of intellectual property entered into the computer and generate an asset having attributes incorporating the captured data; and
the intellectual asset management instructions store the generated asset to the database.

2. The system of claim 1, wherein the intellectual asset management instructions include at least one set of stand alone instructions directed to a specific portion of the intellectual asset management process.

3. The system of claim 2, wherein the stand alone set of instructions perform strategic planning functions.

4. The system of claim 2, wherein the stand alone set of instructions perform portfolio management functions.

5. The system of claim 2, wherein the stand alone set of instructions perform invention analysis functions.

6. The system of claim 2, wherein the stand alone set of instructions perform inventor performance functions.

7. The system of claim 2, wherein the stand alone set of instructions perform patent procurement functions.

8. The system of claim 2, wherein the stand alone set of instructions perform licensing management functions.

9. The system of claim 2, wherein the stand alone set of instructions perform conflict and assertion functions.

10. The system of claim 2, wherein the stand alone set of instructions perform competitive intelligence functions.

11. The system of claim 1, wherein the intellectual asset management instructions interact with a common asset repository.

12. The system of claim 11, wherein the intellectual asset management instructions perform functions available to any asset resident in the common asset repository.

13. The system of claim 1, wherein the intellectual asset management instructions are programmed to emulate an intellectual property lifecycle and the intellectual asset management instructions transform the attributes of the generated asset at different stages of the lifecycle.

14. The system of claim 13, wherein the intellectual asset management instructions are programmed to interact with search engines to perform asset related searches to return a hit list.

15. The system of claim 14, wherein intellectual asset management instructions associate the returned hit list of search results with a generated asset.

16. The system of claim 1, wherein the intellectual asset management instructions generate assessment criteria for a generated asset.

17. The system of claim 16, wherein the intellectual asset management instructions generate scoring numbers based on responses to the generated assessment criteria.

18. The system of claim 17, wherein the intellectual asset management instructions modifies the attributes of a specified asset due to scoring numbers generated for that asset.

19. A method for managing intellectual assets, comprising:
providing information regarding a piece of intellectual property;
capturing the information provided; and
generating an asset having attributes which identify a specific piece of intellectual property.

20. A computer readable medium having instructions for execution by a computer for performing a method, comprising:
capturing information regarding a specific item of intellectual property; and
generating an asset having attributes which identify the specific piece of intellectual property.
